(19) United States
(12) Patent Application Publication
(10) Pub. No.: US 2007/0174341 A1
(43) Pub. Date: Jul. 26, 2007

(54) E-COMMERCE AND INVESTMENT SYSTEM AND METHOD

(76) Inventors: VARMA SARIPALLI, FRANKLIN, MA (US); VIJAY KONDA, SHARON, MA (US)

Correspondence Address: AKC PATENTS, 215 GROVE ST., NEWTON, MA, 02466, US

(21) Appl. No.: 11/623,475

(22) Filed: Jan. 16, 2007

Related U.S. Application Data
(60) Provisional application No. 60/760,197, filed on Jan. 19, 2006.

(51) Int. Cl. G06F 17/00

(52) U.S. Cl. 707/104.1

(57) ABSTRACT

An online network based e-commerce and investment system for online selling and investing in non-physical goods includes a listing management module, a distribution management module, a trading management module, an account management module and a disbursal management module. The listing management module is used to generate online product listings of the non-physical goods and to generate online listings of ownership shares of the non-physical goods. The distribution management module is used for online selling and for online distributing of copies of the non-physical goods. The trading management module is used for online investing and trading of the ownership shares of the non-physical goods. The account management module creates and maintains user accounts and keeps track of ownership share holdings for each user. The disbursal management module distributes profits from the sales of the non-physical goods to the user accounts. Non-physical goods include music, video, e-books, publications, patents and designs among others.

### CROSS REFERENCE TO RELATED CO-PENDING APPLICATIONS

This application claims the benefit of U.S. provisional application Ser. No. 60/760,197 filed on Jan. 19, 2006 and entitled A NEW INVESTMENT SYSTEM AND METHOD which is commonly assigned and the contents of which are expressly incorporated herein by reference.

### FIELD OF THE INVENTION

The present invention relates to a new e-commerce and investment system and method for online selling of non-physical goods and investing in ownership shares of non-physical goods and more particularly to listing, buying, trading, selling, and distributing of profits of ownership shares of non-physical goods.

### BACKGROUND OF THE INVENTION

Currently, there are e-commerce systems for distributing and selling non-physical goods such as music, videos and books, among others. Examples of these e-commerce systems include Apple's iTunes™ for music and Amazon's e-books. These e-commerce systems offer products that are produced by music companies, publishing companies, movie and video companies, among others. It is very difficult for an individual owner or creator of these non-physical goods to bring them to the e-commerce market and to sell them directly to the public.

Stock markets allow companies to offer investment opportunities to the public. Stock exchange systems provide listing of company shares and enable people to buy and sell shares of the listed companies. However, these stock exchange systems do not allow an entity to list shares of a product and to seek investment returns for the shares of the listed product.

Accordingly, there is a need for an e-commerce system and an investment system that would address the above identified market needs.

### SUMMARY OF THE INVENTION

In general, in one aspect, the invention features an online network based e-commerce and investment system for at least one non-physical good including a listing management module, a distribution management module and a trading management module. The listing management module includes means for generating an online product listing of the non-physical good and means for generating an online listing of ownership shares of the non-physical good. The distribution management module includes means for online selling and means for online distributing of one or more copies of the non-physical good. The trading management module includes means for online investing and trading of the ownership shares of the non-physical good listing.

Implementations of this aspect of the invention may include one or more of the following features. The system further includes an account management module and the account management module includes means for generating online user accounts, means for managing the online user accounts, means for maintaining user personal information, means for keeping track of user holdings of the ownership shares of the non-physical good in the user accounts, means for depositing profits from the selling of the copies of non-physical goods in the user accounts and means for transferring funds in and from the online user accounts. The system further includes an online database for storing the online user accounts information data, the online product listing data, the online listing data of ownership shares, and receipt/sales data for the copies of non-physical good. The system further includes a disbursal management module and the disbursal management module includes means for online distributing of profits from the selling of the copies of the non-physical good into the online user accounts. The system further includes at least one online store for selling the copies of non-physical good. The system further includes at least one sales channel for distributing the copies of non-physical good to the online store. The system may include a plurality of product listings of non-physical goods, a plurality of listings of ownership shares of the non-physical goods, a plurality of online stores and a plurality of sales channels. The means for online distributing of copies of the non-physical goods may include a plurality of distribution queues. The distribution queues are associated with one or more of the online sales channels. The online sales channels are associated with one or more of the online stores. The system may further include means for selecting one or more of the distribution queues, one or more of the online sales channels and one or more of the online stores for online selling the copies of non-physical goods. The non-physical goods may be music recordings, video recordings, electronic books, patents, designs, drawings, reports, electronic tickets, electronic gift certificates, electronic tokens, electronic journals, electronic magazines, electronic newspapers, customized content, packaged subject matter, or combinations thereof. The online stores may be online music stores, online video stores, online bookstores, online patent and design license stores, online content stores, online news store, online magazine store, online learning centers, or combinations thereof. The account management module may include an account management user interface and the account management user interface includes a login screen, a logout screen, an account generation screen, a password setting and changing screen, a user personal information modification screen, a transfer fund screen, a transaction verification screen, ownership share holdings verification screen, a display screen for all ownership shares owned by a user, a performance display screen for all ownership shares owned by a user, an account balance screen for each user. The user personal information may include user identifications, passwords, addresses, bank account information and numbers, website information, e-mail addresses, or combinations thereof. The listing management module may further include a listing user interface and the listing user interface includes a screen for entering product listing information, a screen for online uploading product material for the non-physical good, a screen for updating the product material of the non-physical good, a screen for allocating number of ownership shares and price per ownership share of the non-physical good, a screen for browsing existing product listings, and a screen for browsing listings of ownership shares for non-physical goods. The means for online trading of the ownership shares include online selling, online buying, online exchanging, online trade matching of a sell order with a buy order, online fulfilling of trade orders and online reconciling and deducting costs associated with trade orders of the ownership shares. The trading management module includes a trading user interface and the trading user interface includes a screen for displaying number of available ownership shares and price per share of the non-physical good, a screen for placing a buy trade order for the ownership shares of the non-physical good, a screen for placing a sell trade order for the ownership shares of the non-physical good, screens for confirmation of buying and selling of ownership shares of the non-physical good, and a screen for displaying the buy and sell trade order status. The disbursal management module further includes means for verifying vesting of the profits from the selling of the copies of the non-physical good. The disbursal management module further includes means for deducting costs and commissions from the profits from the selling of the copies of the non-physical good. The listing management module further includes means for proposing a change of the online listing of the ownership shares of the non-physical good, means for voting on the proposal for change by all owners of the ownership shares of the non-physical good, and means of implementing the voting result. The listing management module further includes means for delisting the online listing of the ownership shares of the non-physical good. The online product listing of the non-physical good and the online listing of ownership shares of the non-physical good are generated by an owner of the non-physical good and wherein the listing management module further includes means for entering proof of ownership of the non-physical good by the owner. The listing management module further includes means for reviewing, verifying and approving the online product listing and the online listing of ownership shares of the non-physical good by an external entity. The listing management module further includes means for providing pricing suggestions for the product listing. The listing management module further includes means for providing valuation and number of ownership shares suggestions for the non-physical good. The sales channel includes a sales agreement and the agreement includes variables for determining pricing of the product listing. The system may further include means of entering directly an online product listing without engaging the listing management module.

In general, in another aspect, the invention features a method for online selling and online investing in at least one non-physical good including the following steps. First, providing at least one non-physical good. Next, providing an online network based e-commerce and investment system comprising a listing management module, a distribution management module, and a trading management module. The listing management module includes means for generating an online product listing of the non-physical good and means for generating an online listing of ownership shares of the non-physical good. The distribution management module includes means for online selling and means for online distributing of one or more copies of the non-physical good. The trading management module includes means for online trading of the ownership shares of the non-physical good. Next, generating an online product listing of the non-physical good and an online listing of ownership shares of the non-physical good with the listing management module. Next, selling and distributing online one or more copies of the non-physical good with the distribution management module. Next, investing and trading online the ownership shares of the non-physical good with the trading management module.

Among the advantages of this invention may be one or more of the following. The system allows owners of non-physical products to offer their products for online sale, generate listings of ownership shares of these non-physical products and offer investment opportunities to the public in these ownership share listings. The system allows individuals or other third party entities to own part of such ownership share listings and to receive income form the product sale revenue stream. The system also allows trading of these ownership share listings and incurring gains or losses.

### BRIEF DESCRIPTION OF THE DRAWINGS

Referring to the figures, wherein like numerals represent like elements throughout the several views:

FIG. 1 is an overview diagram of the investment system of this invention;

FIG. 2 is a block diagram of one embodiment of the account management module;

FIG. 3 is a block diagram of one embodiment of the listing management module;

FIG. 4 is a block diagram of one embodiment of the trading management module;

FIG. 5 is a block diagram of one embodiment of the distribution queues and sales channels;

FIG. 6A is a block diagram of a sales transaction of a song;

FIG. 6B is a block diagram of a sales transaction of a streaming video;

FIG. 6C is a block diagram of a sales transaction of an e-book;

FIG. 6D is a block diagram of a sales transaction of a patent or a design;

FIG. 7 is a block diagram of one embodiment of the disbursal module;

FIG. 8 is a block diagram of the major entities of the system;

FIG. 9 is a block diagram of entity samples of the system.

FIG. 10A is one embodiment of a User Interface (UI) screen for creating a listing;

FIG. 10B is one embodiment of a User Interface screen for managing the products of a listing;

FIG. 10C is one embodiment of a User Interface screen for selecting the product type for a new product that is to be added to the listing;

FIG. 11 is one embodiment of a UI screen for uploading product material for a music listing;

FIG. 12 is one embodiment of a UI screen for providing proof of ownership details for the music listing of FIG. 11;

FIG. 13 is one embodiment of a UI screen for setting up sales channels for the music listing of FIG. 11;

FIG. 14 is one embodiment of a UI screen depicting terms of agreement between the user and the exchange institution;

FIG. 15 is one embodiment of a UI screen displaying the details of a sales channel for review of the user of the system;

FIG. 16 is one embodiment of a UI screen for searching a listing and displaying the characteristics of the listing on the screen;

FIG. 17 is one embodiment of a UI screen displaying the detailed performance of a listing.

FIG. 18 is one embodiment of a UI screen for reviewing the complete details about a listing;

FIG. 19 is a one embodiment of a UI screen for placing a buy or sell order for trading a listing;

FIG. 20 is a one embodiment of a UI screen for reviewing a buy order;

FIG. 21 is one embodiment of a UI screen for reviewing a sell order;

FIG. 22 is one embodiment of a UI screen depicting a placed sell order;

FIG. 23 is one embodiment of a UI screen depicting a placed buy order;

FIG. 24 is one embodiment of a UI screen showing the status of a placed trade order for an account;

FIG. 25 one embodiment of a UI screen showing details of a channel;

FIG. 26 is one embodiment of a UI screen displaying the investment portfolio for an account; and

FIG. 27 is a flow diagram of the online e-commerce and investment process of this invention.

### DETAILED DESCRIPTION OF THE INVENTION

This invention provides an online network based e-commerce and investment system and a method for selling and distributing online non-physical goods and products and for trading and investing online in ownership shares of these non-physical goods and products.

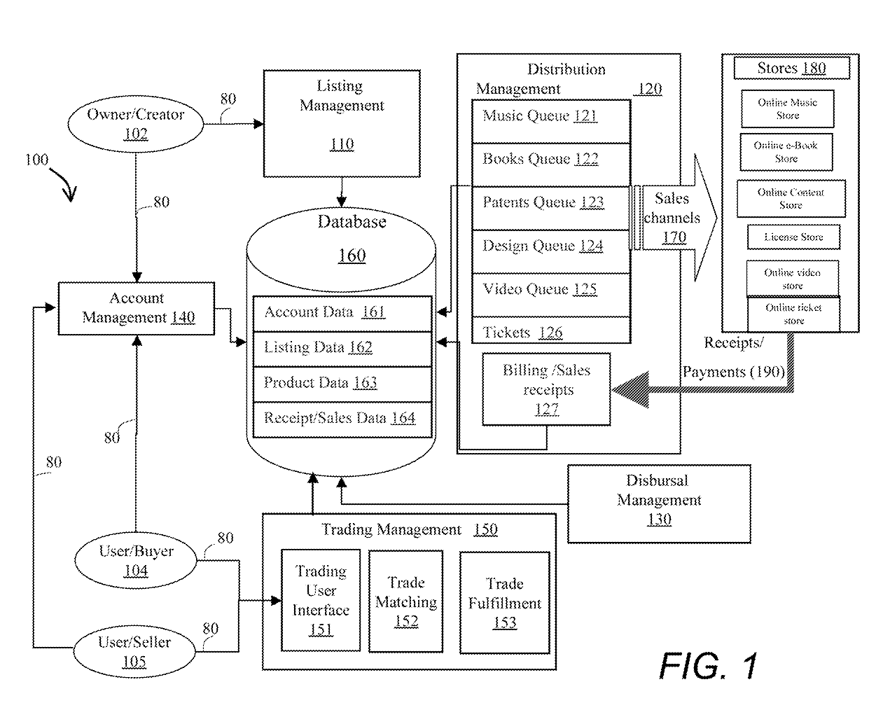

Referring to FIG. 1, a new online network based e-commerce and investment system 100 (also referred to as exchange system 100) includes a listing management module 110, a distribution management module 120, a trading management module 150, an account management module 140, a disbursal management module 130, a database 160, sales channels 170, and online stores 180. The online system 100 is a network application that is stored in a server and can be accessed by users 104, 105, owners of the non-physical goods and products 102 and other investors via a network connection 80. In one example, the system 100 is accessed via a website having a Uniform Resource Locator (URL) address of www.ipshare-systems.com. System 100 is used to list online non-physical goods and products, sell and distribute the listed products online, to generate a listing of ownership shares for each listed non-physical good and product and to invest and trade the product ownership shares online. System 100 is also used to distribute profits from the sale of the non-physical goods and products among the investors of the product ownership shares and to keep track of all investment accounts. The general term “exchange” includes the system 100 and the business entity which sets up and maintains the system infrastructure, makes marketing arrangements with the sales stores, creates and manages the internal sales stores and operates all the core facilities described in this document. The general term of a “user” refers to a registered holder of an account in the system 100. A user in the system always needs to be authenticated before being able to perform any operation or task in the system.

Examples of non-physical goods, products and digital goods 90 that can be sold online and whose ownership shares can be traded online with the system 100 include intellectual properties, creative works and other non-physical properties such as music recordings and compositions, video recordings and movies, electronic books (e-books), electronic magazines, electronic newspapers, electronic journals, electronic tickets, electronic gift certificates, images, software, patents, trademarks, domain names, designs, advertising time slots and works of art whose use can be sold indefinitely. E-books are books stored, transported and read in electronic format. Products that are in electronic format are usually protected by digital rights management systems. Digital rights management (DRM) generally refers to technologies or systems used to control the use of electronic content. Examples of DRM systems are Windows Media digital rights management, Apple iTunes, copy protected CDs, and software license activations schemes, among others. Other examples of non-physical goods or products 90 include content that a company can spin off, pharmaceutical formulae, service protocols for medical treatments, maintenance of automobiles, and business processes, among others.

The owner or the creator or the author 102 of the non-physical good or product 90 logs into the system 100 and uses the listing management module 110 to add the non-physical good or product 90 to the system and to generate a listing of ownership shares for the non-physical good 90. The terms of product owner 102 refers to an entity or a person who has the ownership rights on the product 90. The product owner needs to have an account in the system to be recognized as owner of a product listed in the system. In one example, the product owner 102 is a person who created a work of art or music. In another example, the product owner may be an entity which legally owns the rights to a song or portfolio of songs. The product material and the listing of the ownership shares of the non-physical good are stored in the database 160 as product data 163 and as listing data 162, respectively. As referred in this document, product material includes all the electronic files, license agreements, license systems, and activation systems, which are required to make the product available for sale and use of the product by the consumers. These electronic files may include music files, video files, electronic images, e-books, drawing files in proprietary formats, license agreements, and links to external services, among others.

The users of the system 100 use the account management module 140 to created personal accounts in order to be able to use the functions of the system 100. All account information is stored in the database 160 as account data 161. Database 160 is a collection of information stored in a computer and is managed by a database management system. A database transaction is a unit of work carried out with a database management system. A directory is a database for storing and retrieving attribute based information. Unlike relational databases these are optimized for fast searching and retrieving. User logins, authentication information, simple attribute information is typically stored in a directory.

The trading management module 150 is a trading platform used for trading holdings of ownership shares of the various non-physical goods 90 among registered users. A trading platform is a system that matches buy orders and sell orders and fulfills them. These are generally sophisticated systems which can deal with different sizes of orders, different offering prices and partial fulfillments. The distribution management module 120 of the system 100 makes the listed products available to distribution queues 121-126 and facilitates the sale of copies of the product 90 through sales channels 170 linked to online retail stores 180. A distribution queue is a location in the system 100 which houses the product 90 and makes the product 90 available for distribution. The receipts/payments 190 from the sales of the product 90 are collected in the billing/sales receipts records 127 of the distribution management module 120 and the proceeds of the sales of the product are stored as receipts/sales data 164 in the database 160. The disbursal management 130 module allocates the receipts from the receipt/sales data 164 to the listing data 162 of the database 160 and distributes the profits from the sales of the products to the accounts of the listing owners, i.e., the users of the system who own shares of the listing. A user/buyer 104 or a user/seller 105 are investors for the ownership shares of the non-physical good and they use the system 100 to buy, sell, or exchange product ownership shares. These investors also share the profits from the sale and distribution of the non-physical goods and products according to the number of ownership shares they own.

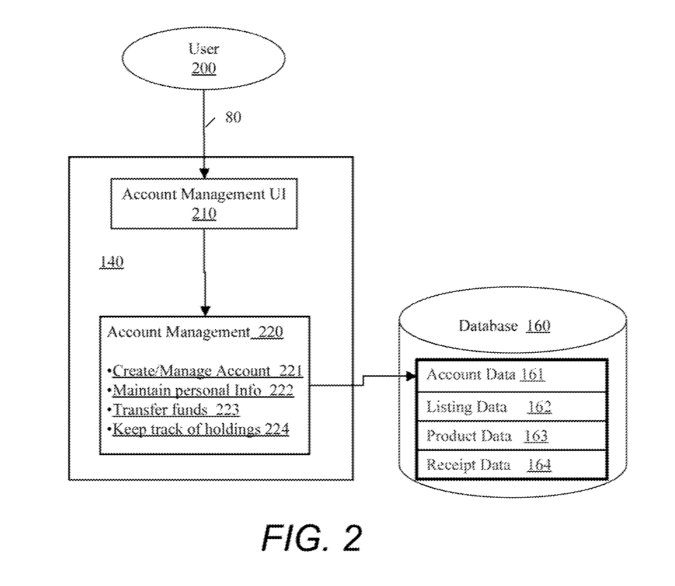

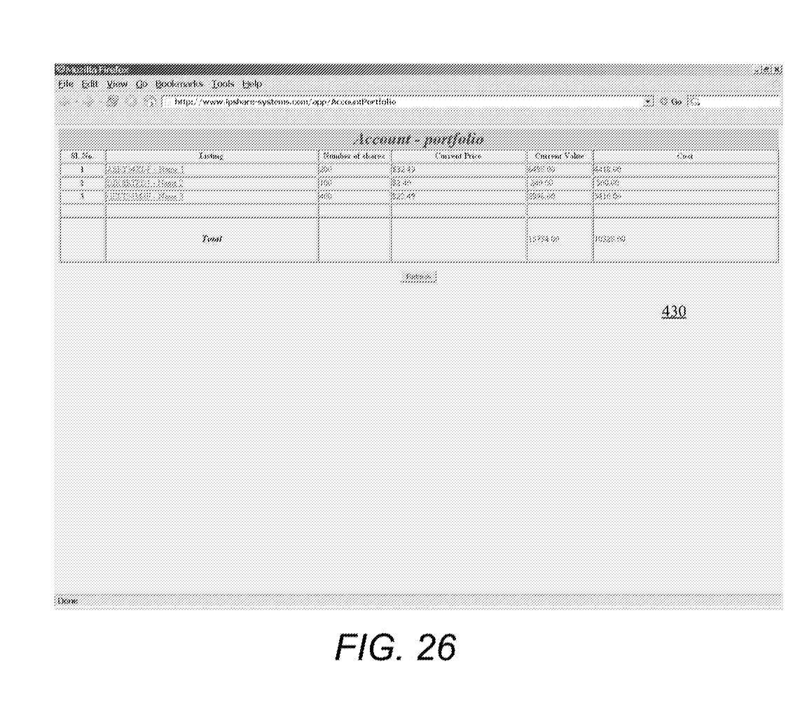

The system 100 requires the users to create an account in order to access any services offered by the system. The user is identified by a unique user identification name throughout the system and uses a password to securely access his account. Referring to FIG. 2, a user 200 accesses the system 100 via the Internet 80 and clicks on the account management module 140. The account management module 140 includes an account management user interface (UI) 210 and an account management application 220. The account management application 220 includes the functions of login into the account, logout, creating and managing an account 221, maintaining of personal information 222, transferring of funds 223, and keeping track of holdings 224. The account management UI 210 includes a set of user interface screens that provide access to the functions offered by the account management application 220. Examples of these user interface screens include login screen, logout screen, account creation screen, password change screen, personal information modification screen, transfer funds screen, verifying transactions screen and verifying holding screen, among others. The create/manage account function 221 allows a user to create an account with the system 100, enter personal information, set passwords and user identification name, login, logout, verify passwords, and delete accounts. The maintenance of personal information function 222 allows the user to modify personal information such as passwords, address, bank accounts, social security number, and e-mail information, among others. The transfer funds function 223 allows the user to transfer funds from external bank accounts to the system account or vice versa. The tracking of holdings function 224 tracks holdings that include the list and number of ownership shares owned by the user for the different listed products, cash balances, price of the shares and total value of the account. The account management application 220 links to the database 160 and stores all account information in the account data 161. The account management application 220 also displays the stored account information, account balances, account holdings, number of shares per holding, current price per share, current value of holding and total value of the account, as shown in the screen shot of FIG. 26. The account management application 220 also provides performance evaluation of an individual holding of ownership shares and for the entire portfolio of holdings. The account management application 220 also allows a user to create a virtual portfolio of holdings of ownership shares and track the performance of such a virtual portfolio.

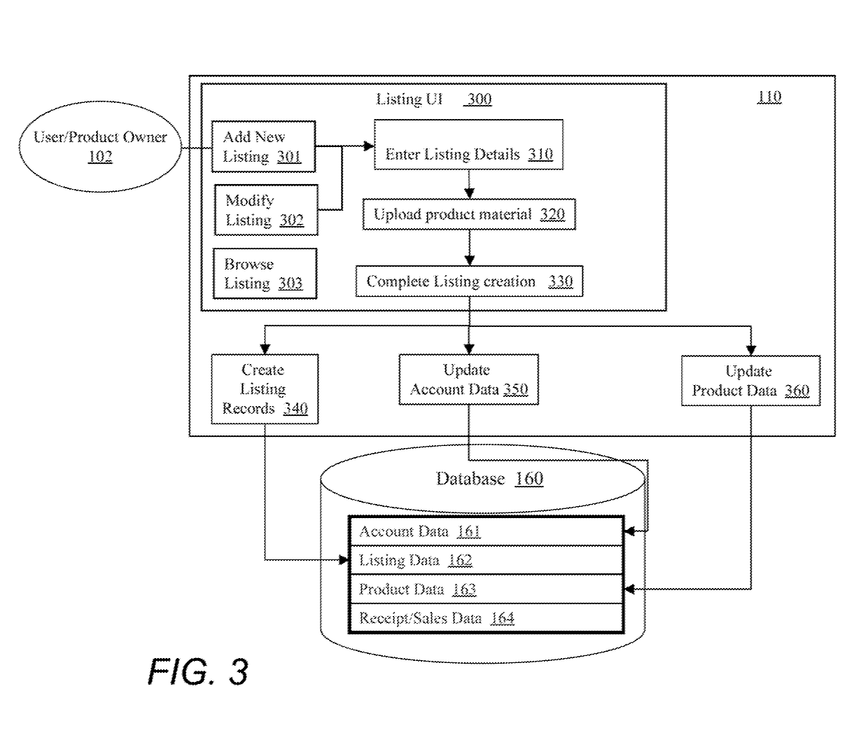

Referring to FIG. 3, a user/product owner 102 of a non-physical good 90 logs into the system 100 and accesses the listing management module 110. The listing management module 110 is an application that allows a user to add his product 90 to the system 100 and to generate a listing of his product and a listing of ownership shares of his product. The listing management module 110 includes a listing UI 300 that provides functions allowing the user 102 to add a new listing 301, modify an existing listing 302 and browse existing listings 303. The processes of adding a new listing 301 or modifying and existing listing 302 includes entering/modifying the listing details 310, uploading the product material 320 and completing the listing creation 330. The listing management application 110 generates the listing records of the ownership shares 340 and deposits them in the listing data 162 of the database 160. The listing management module 110 also facilitates the uploading of the product material 320 and updates the product data and the account data 350 and enters them in the product data 163 and in the account data 161, respectively, of the database 160. In one example, the listing details include the name of the listed product, the type of the listing, classification of the product, total number of ownership shares allocated to the listing, product pricing, and share pricing. For uploading of the product material (320), the user is provided with input screens for the different types of products. If the product is a book, the screen provides a facility to upload image or text files, and allows the user to enter the name of the author, title, topic, and a brief description of the subject, among others. Similarly, if the product is a video, the screen presents a facility to upload a video file and allows the user to enter the name of the director, actors and a brief description of the plot. Initially all available ownership shares assigned to the listing are allocated to the user/owner 102 of the product 90. The user/owner then has the option to make a number of ownership shares available to the public and to offer them for sale. The listing management module 110 also provides suggestions for the valuation and enumeration of the ownership share based on factors including type of listing, type of product, past performance of similar type of listings, and sales of similar products. Module 110 also provides pricing suggestions for the sale of product 90 online. The listing management module 110 may also include an electronic agreement certifying that the user/owner 102 is the original author/owner of the product 90. The user/owner may be required to explicitly agree to the terms of this agreement. The listing management module 110 may also include a verification process for verifying the identity of the user, authenticity of the product and proof of ownership of the product by the user 102. The listing management module 110 also sends a notification to the distribution module 120 and trading module 150 upon successful uploading of the product material and creation of the listing of ownership shares of the product.

As was mentioned above database 160 stores all account data 161, all ownership share listing data 162, all product data 163 and all receipt/sales data 164. Account data 161 includes information regarding all user accounts such as user name, address, listings owned by each user and number of shares owned in each listing. Listing data 162 includes information related to all the listings of ownership shares such as owner, type of listing, listed date, total number of shares and number of shares available for sale. Product data 163 includes information regarding all the products listed in the system 100 such as product type, file, distribution channels, available formats and pricing information.

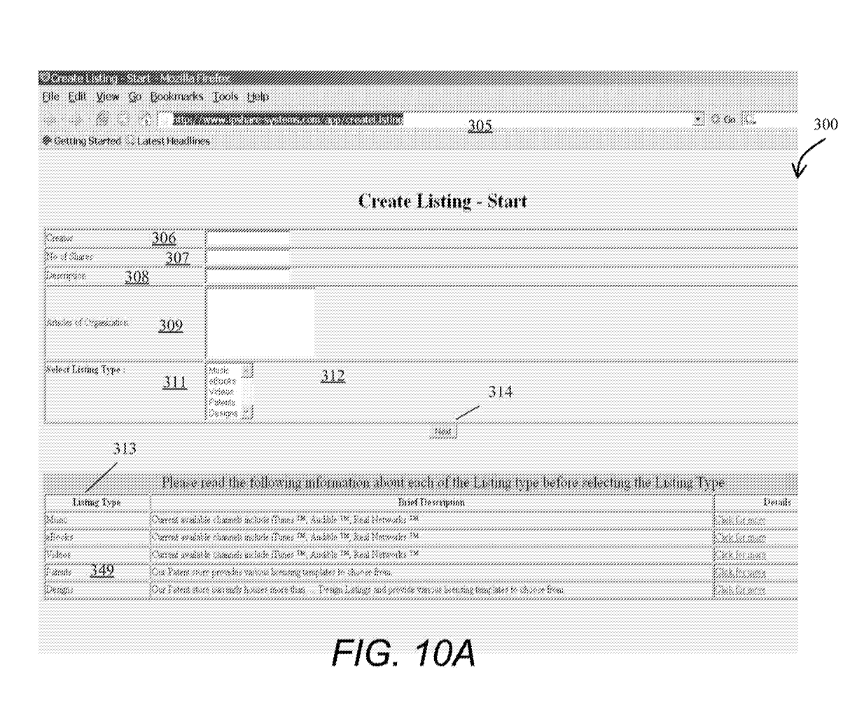

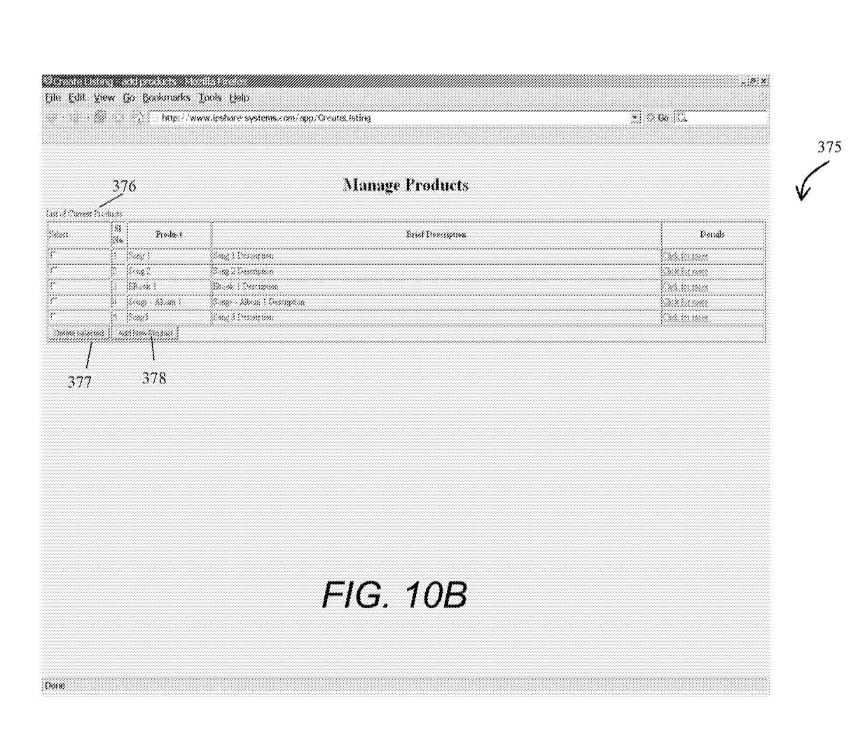

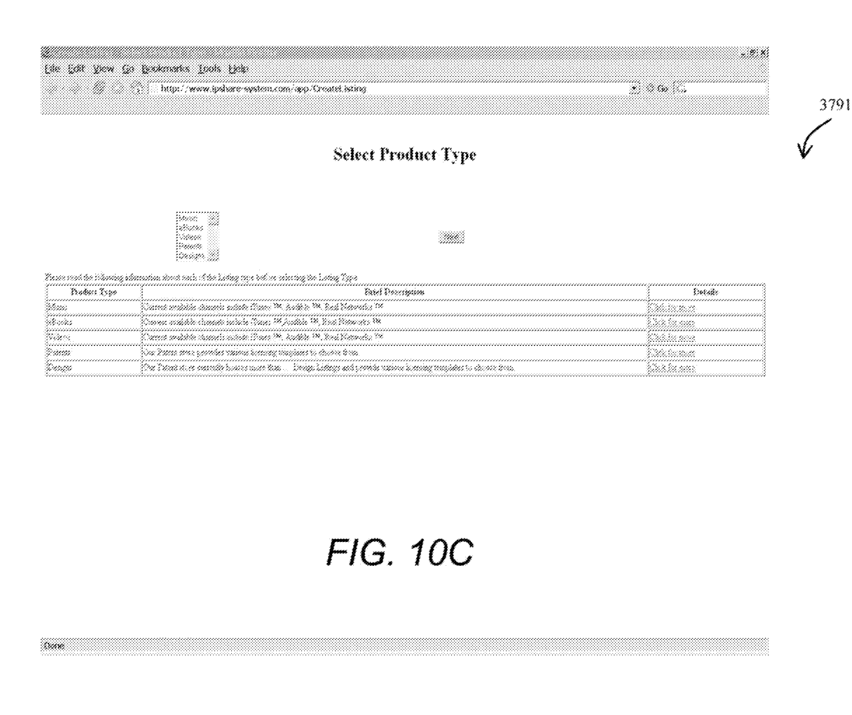

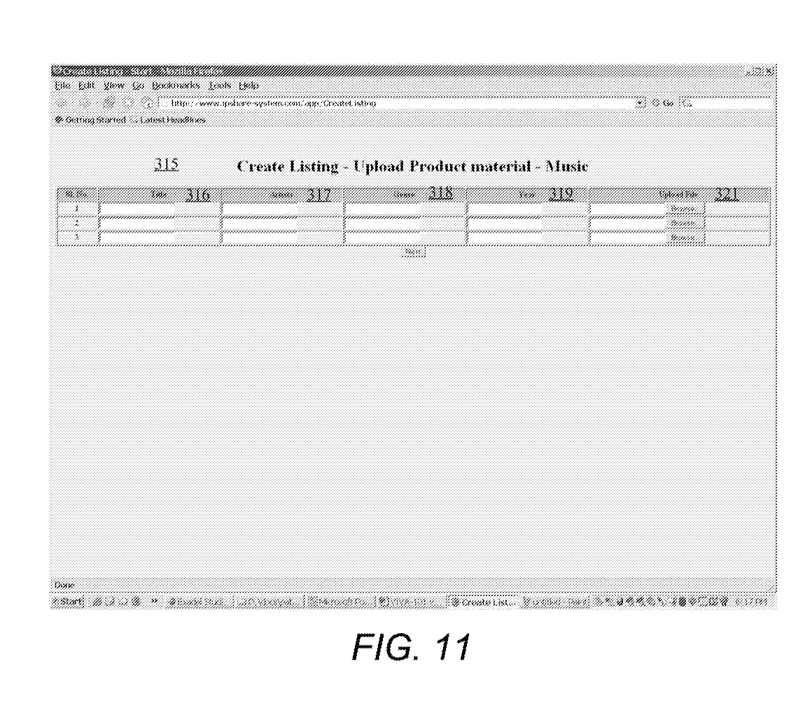

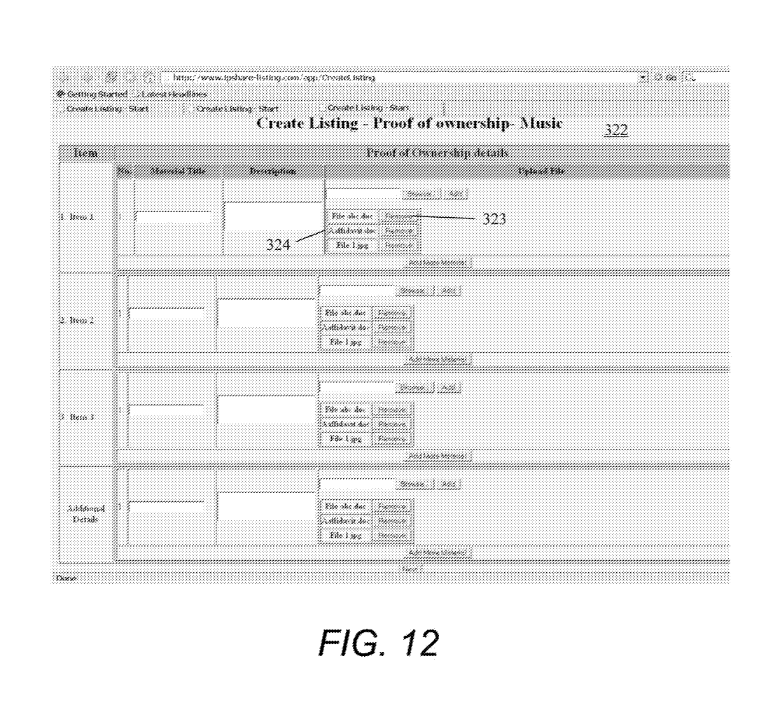

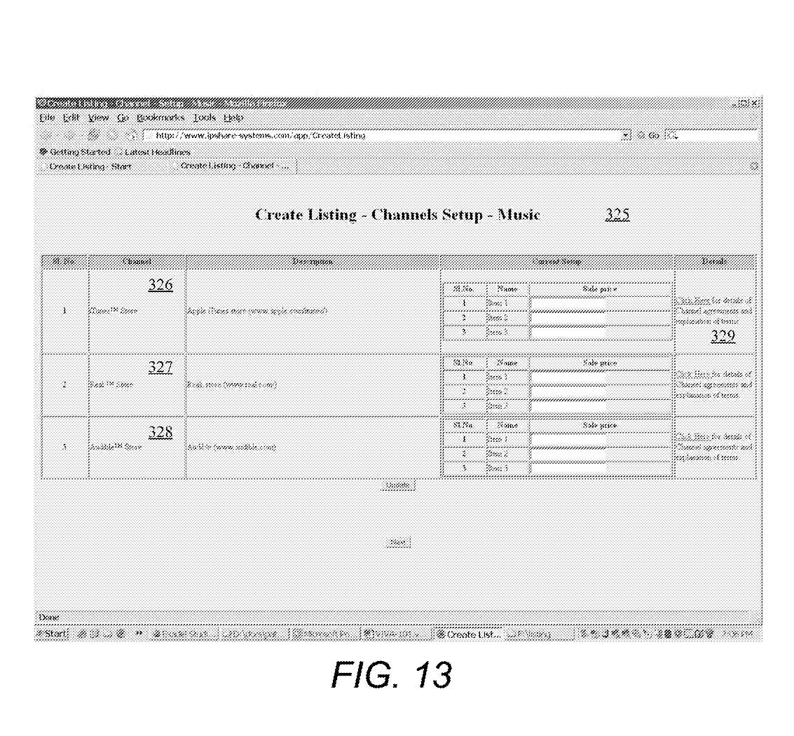

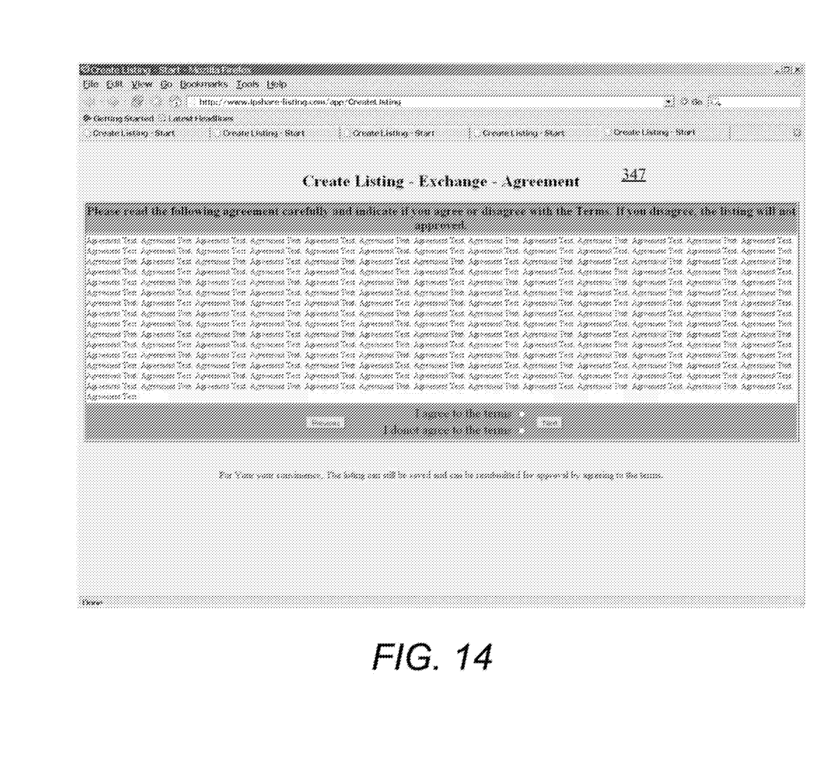

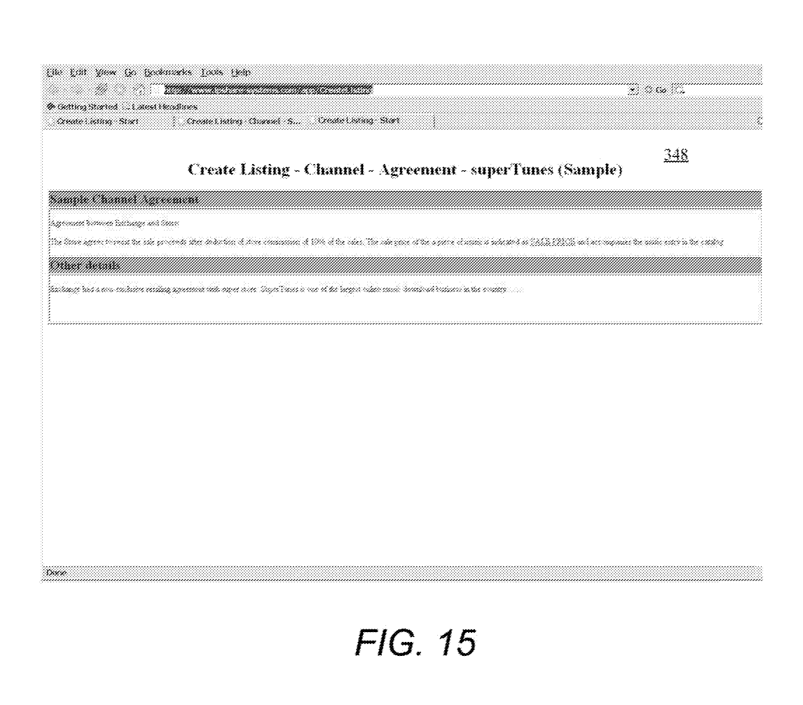

The listing UI 300 is a graphical user interface that includes a set of screens that guide the user 102 step-by-step in the process of adding a product 90 and generating a listing of ownership shares for the product. Referring to FIG. 10A, a user 102 accesses the website of the exchange system 100 via the Internet by typing the URL address: http://www.ipshare-systems.com and after creating an account and login into the account clicks the “create listing” tab. This action leads to the create listing-start screen 305. The create listing-start screen 305 includes input fields for the name of the creator 306, number of shares 307, description of the listing 308, articles of organization 309, and select listing type 311. The select listing type 311 field includes the options 312 of music, e-books, videos, patents, and designs, among others. For each listing type there is information 313 available that can be accessed before making a selection. Examples of the listing type information include current available channels for distribution, available licensing templates, and number of items per type. After entering this information the user clicks the next button 314 which leads him to the upload product music screen 315. In the example of FIG. 11, the upload product screen 315 is for a musical recording product and includes input fields for title of the song 316, name of the artist 317, genre 318, and year 319. The upload file button 321 uploads the song and stores it in the product data 163 of the database 160. The next screen 322 asks the user to provide proof of ownership for each uploaded product, which may be an original document 323 or a signed affidavit 324, shown in FIG. 12. Next screen 325 asks the user to select the distribution channels. In the example of FIG. 13, the product is a music recording and the available channels include iTunes™ 326, Real™ Store, and Audible™ Store. For each available sales channel there is a detailed agreement listed, which is accessed by clicking the appropriate tab. For the iTunes™ store 326, the agreement is reached by clicking on tab 329. Referring to FIG. 14, the user is then presented with an exchange-agreement screen 347 and is asked to accept or decline the terms of the agreement. An example of an agreement 348 between the exchange system 100 and a superTunes sales channel is shown in FIG. 15.

Referring to FIG. 10B, a “Manage Product” screen 375 displays the list of products 376 currently contained in an existing listing. This screen also provides the options to modify the listing by adding or deleting a product from the listing, i.e., “Add a Product” 377 or “Delete a Product” 378. When the user selects “Add a Product” 377 the system directs the user to a “Select Product Type” screen 379, shown in FIG. 10C. After selecting the product type, i.e., music, book, video, patent or design, the system directs the user to the Product Attribute and Upload screen for that product type. When the user completes all the details necessary to add this product to the existing listing, the user is directed to the “Manage Products” screen 375 which now displays the newly added product to the existing listing. This process allows the user to customize an existing listing or to create a customized new listing.

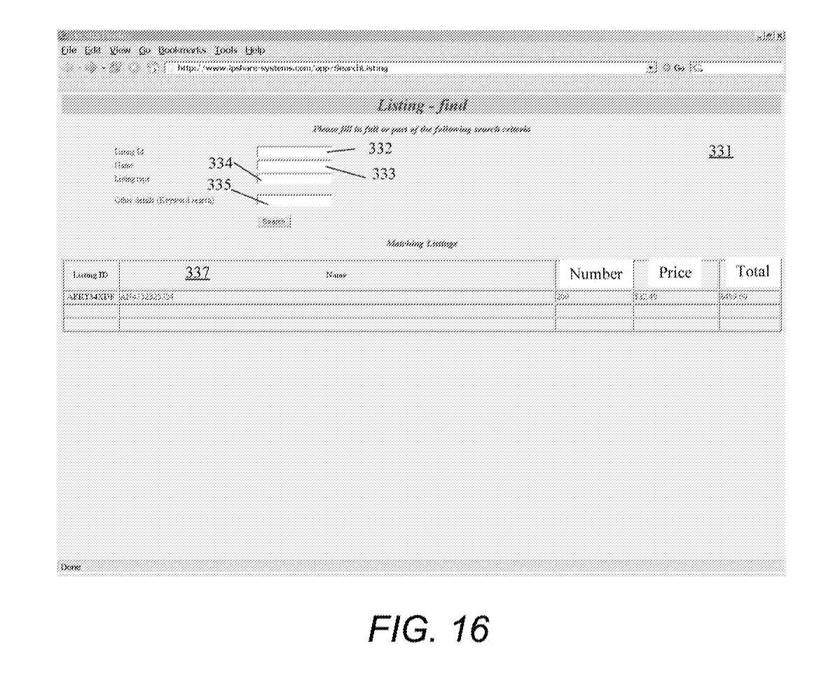

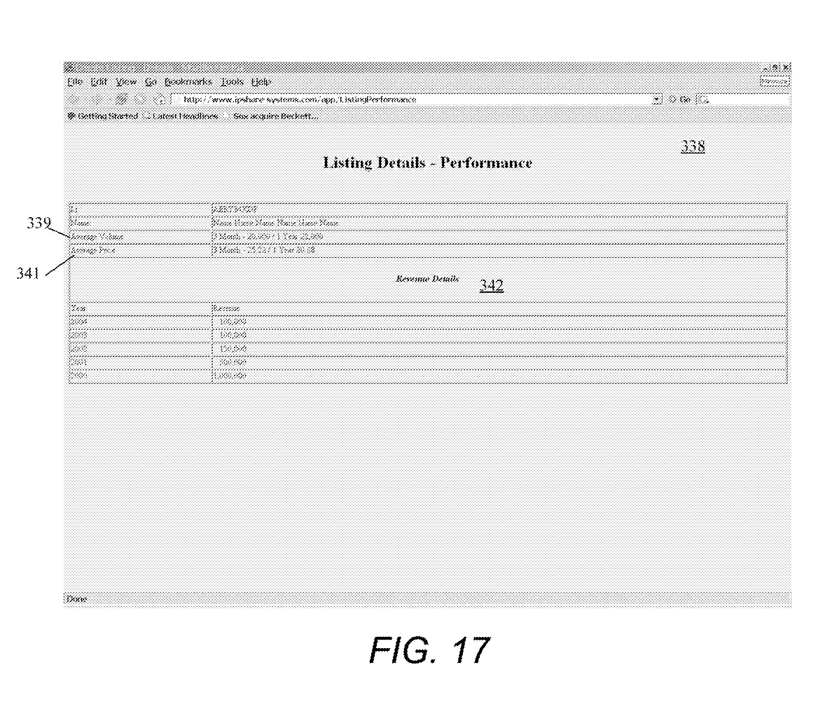

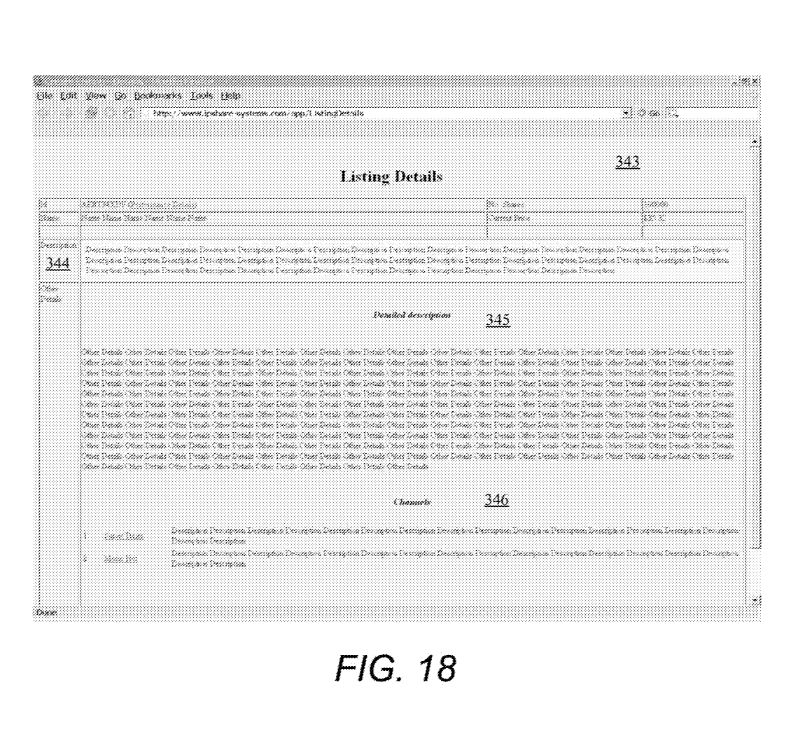

Referring to FIG. 16, the listing UI 300 also includes a search screen 331. The search screen 331 includes input fields for parameters such as listing id 332, name 333, listing type 334, or a keyword 335. The search button 336 leads to the shown result 337 that includes the listing id, name, number of shares, price per share and total value of shares. The listing UI 300 also includes a listing performance screen 338, shown in FIG. 17. The listing performance screen 338 displays the listing name 333, listing id 332, average traded volume 339, average price 341, and the annual revenues derived from the sale of the product of this listing 342. Referring to FIG. 18, the listing details screen 343 includes the listing name 333, the listing id 332, a brief listing description 344, a detailed listing description 345, and the select4ed sales channels 346.

In addition to the provided listing type options the system 100 provides the option of generating a customized listing. The owner of a customized listing product works with the exchange on the agreement details such as sales stores, sales channels and provides all the required information. The exchange uses this information to create the listing in the database. Once the listing is created, the listing is published as a new type of listing and is available to be traded as any other listing. One example of a customized listing is the case of NBC creating a package of all the episodes of three seasons of their hit show “Friends”. This package is sold through video stream sites. The exchange and NBC create a customized listing for this video package and draft and agreement with the various sales channels for the distribution of this package. Once the agreement is complete, the exchange enters all the information about the sales channels and listing details in the database 160 through custom screens and custom programming. Once the listing is added to the database 160, the system 100 makes it available to the users for trading.

In another example of a customized listing, Harvard University creates an on-line degree program and packages this as a product. The product has some fixed costs for paying the course designers and improving the course work every year. The on-line course work is streamed through custom sales channels created for this listing. The information regarding this customized listing and custom sales channels is entered into the system 100 through customized programming, and the listing becomes available to users for trading.

In yet another example of a customized listing, a museum creates a product of all the photographs of the artifacts stored in the museum. The museum sells the rights to view or use these photographs via the system 100. Potential buyers for such a product include publishers of books or advertisement agencies that would include these images in their books or advertisements. The museum receives fees or royalties from such a sale or use. The museum and the exchange work to create a customized sales channel and then add the listing to the system and for trading.

In another example, the non-physical good is a patent and the user/owner selects the patent type of listing 349, shown in FIG. 10A. This leads to the patent attributes screen, the patent product material upload screen and the patent licensing screen. The patent attributed screen contains attributes that are applicable for a patent, such as title, owner, proof of ownership, priority date, patent validity timeframe, patent issuing authority, and subject matter, among others. The patent product material upload screen provides a mechanism for the user to upload his patents documents, drawings and other design documents in one or more formats. The patent licensing screen offers different types of licensing scenarios. In one example of a licensing scenario, the license price is based on the volume of usage and the unit price is per unit per year for the use of this patent technology. The owner is asked to set the per unit price and select the sales channel. In one example of the sales channel, the patent store is hosted by the exchange and the sales channel is established with the in-house patent store. The listing of designs and drawing is closely modeled in the same fashion as that of patents.

The exchange system 100 also provides the facilities to propose amendments of a listing, approve a listing by the system before posting, and delisting of a listing. One or more owners of ownership shares of a listing can present proposals for amendments of the listing. Examples of amendments that the owners may introduce include removing a sales channel, changing the sales price, and adding a new sales channel to the listing. The system 100 provides a facility for the owners to vote on the proposal and the proposal is accepted or rejected by majority voting. The decision is then implemented by the exchange system 100. After a user/owner enters all the information required for creating a listing, an official of the exchange 100 examines the uploaded product material to check if it is an appropriate product for the type of requested listing, reviews and verifies the proof of ownership of the product material and approves the listing if all requirements for this particular listing are met. The listing can be delisted based on prearranged delisting policies agreed upon at the time of the listing.

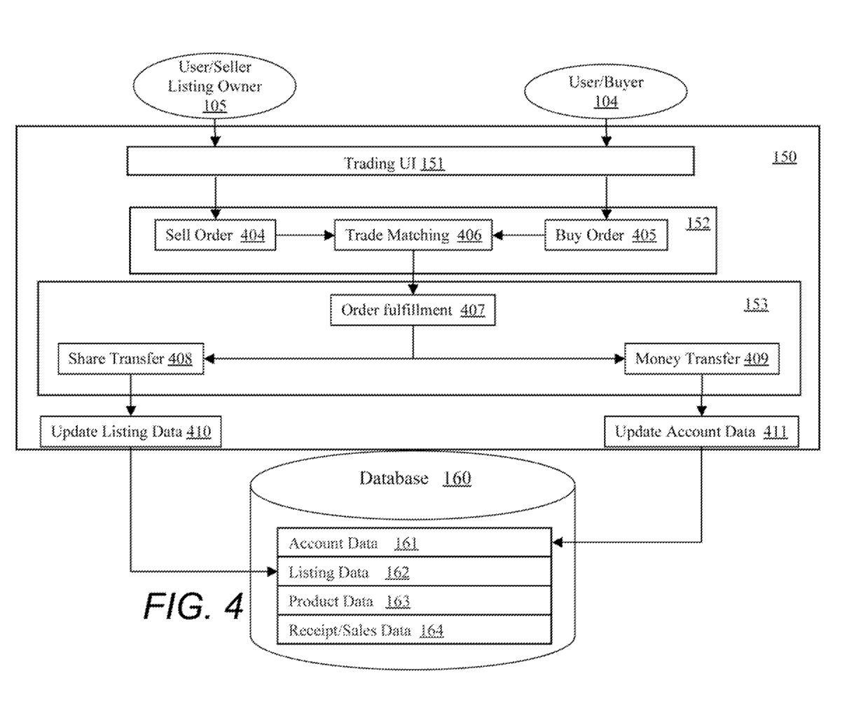

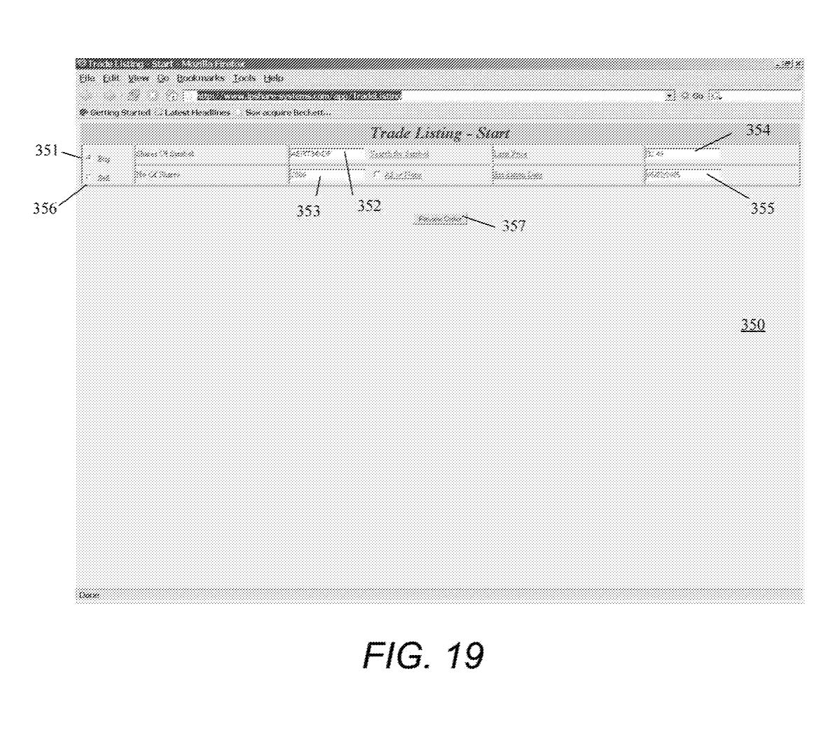

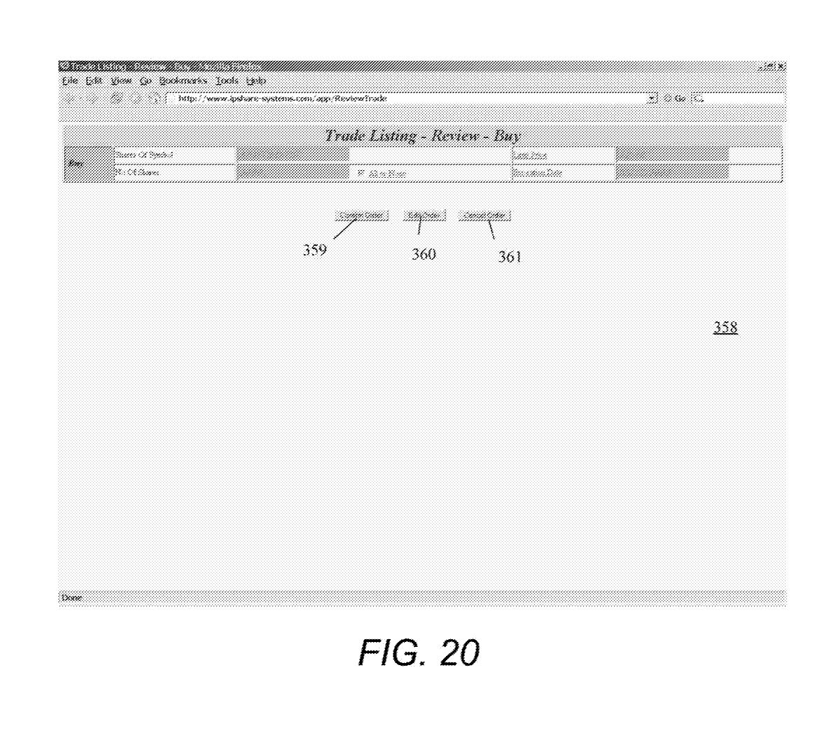

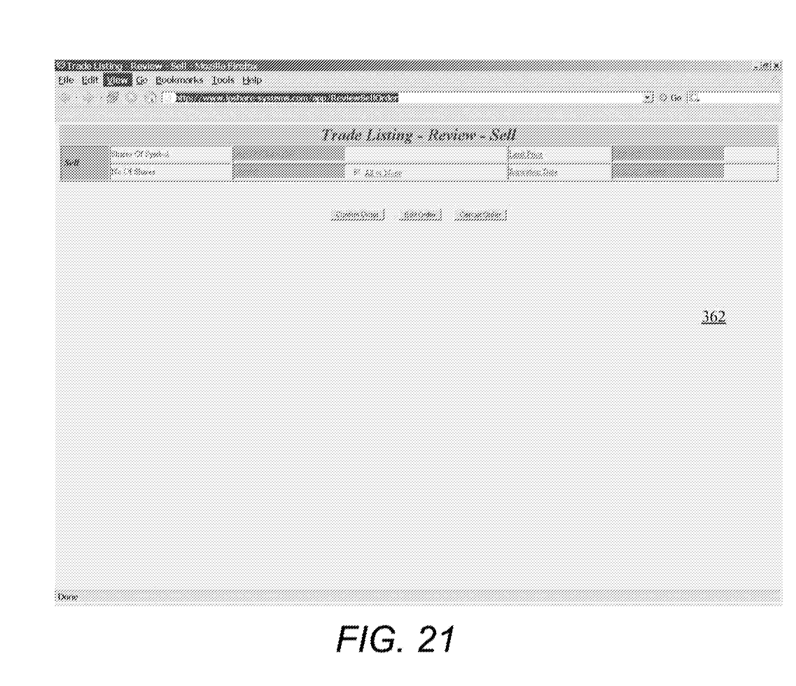

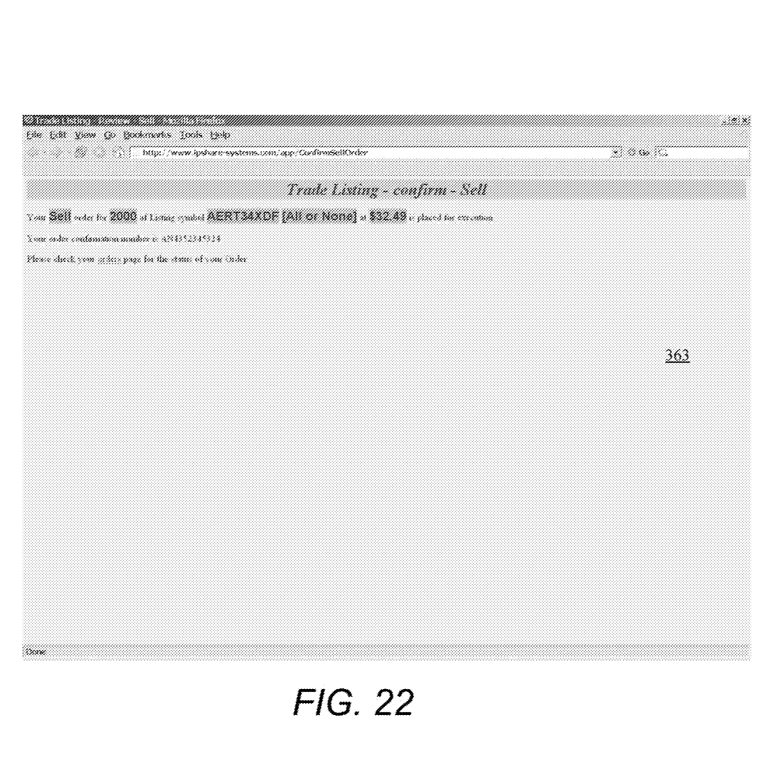

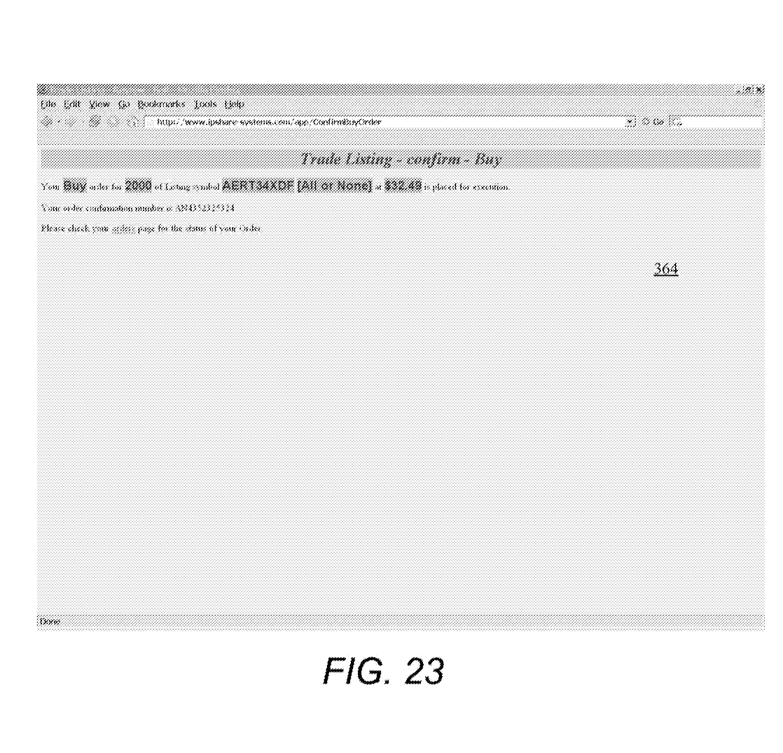

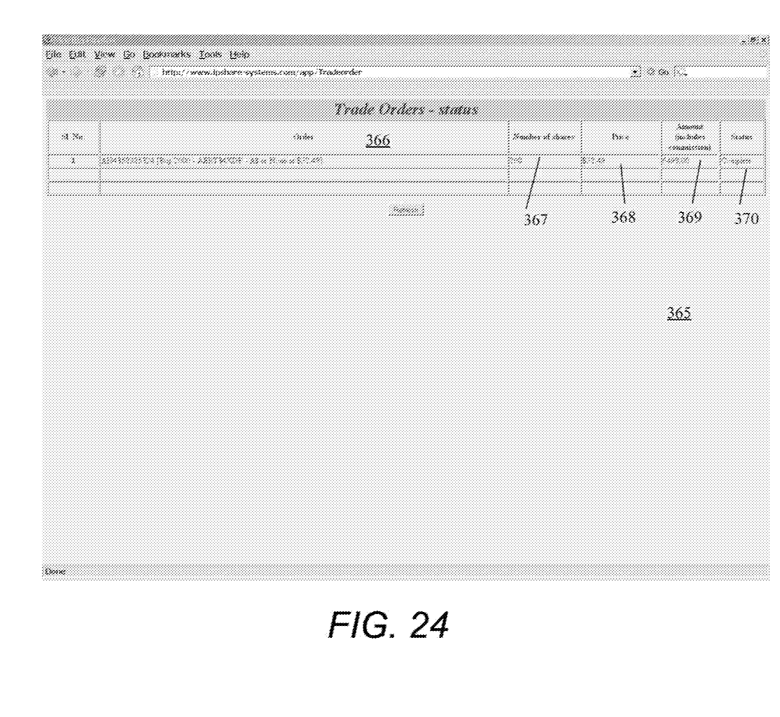

The trading management module 150 is used for trading holdings of ownership shares of the various non-physical goods 90 among registered users. Referring to FIG. 1 and FIG. 4, a listing owner 105 who wishes to sell all or some of his ownership shares logs into the exchange system 100, accesses the trading UI 151 of the trading module 150 and places a sell order 404 for his shares of the particular listing. At the same time, a user/buyer 104 logs into the exchange system 100 accesses the trading UI 151 of the trading module 150 and places a buy order 405 for the same listing. Referring to FIG. 19, trading UI buy order screen 350, depicts the selection of the buy order 351, the share symbol 352, the number of requested shares 353, the limit price per share 354, and the expiration date for the sale order 355. Similar type of parameters are chosen for the sell order 356. Next the buy order is reviewed 357 and the review screen is displayed 358, shown in FIG. 20. The order review screen offers the option to confirm the order as is 359, edit the order 360 or cancel the order 361. Similarly, the sell order review screen 362 offers the option to confirm the order as is 359, edit the order 360 or cancel the order 361, shown in FIG. 21. Upon confirmation of the sell or buy order the sell order confirmation screen 363 or the buy order confirmation screen 364 are displayed, shown is FIG. 22, and FIG. 23, respectively. The trading matching function 152 of the trading module 150 matches the appropriate sell and buy orders 406, reconciles the price differences and proceeds with the trade fulfillment function 153. The trade fulfillment function 153 executes the matched buy and sell orders and upon fulfilling the order 407, transfers the appropriate number of shares to the buyer's account 408 from the seller's account and the appropriate amount of funds to the seller's account from the buyer's account 409. Next, the trade fulfillment function 153 updates 410, 411, the listing data 162 and the account data 161 in the database 160, respectively. The trade matching function 152 sorts the buy orders and sell orders of the same listing and matches the buy orders to the sell orders based on the offer price of the buyer 104 and the asking price of the listing owner 105. If there is an exact match, those orders are matched. If there is more than one match, then the trade matching function 152 uses other priority items such as time the order was placed. If there are no matched orders, the trade matching function 152 reconciles the price differences and reduces the current trading prices of the listing. The buyer 104 and listing owner 105 are able to monitor the price of the share and also change their offer or asking prices using the trading UI 151. The trade matching function 152 waits until the prices are matched and then executes the trade. The trade fulfillment function 153 also deducts the trading transaction fees and commissions from each of the accounts of the buyer 104 and the listing owner 105. Referring to FIG. 24, the status of the order is displayed in the trade order status screen 365, which includes the order number and description 366, the number of shares 367, the price per share 368, the total amount including commissions 369 and the status 370.

The distribution management module 120 of the system 100 receives the product information from the listing data 162 and product data 163 and identifies the appropriate distribution queues 121-126 for placing the product based on the type of the product. The distribution management module 120 then facilitates the sale of copies of the product 90 through sales channels 170 linked to online retail stores 180. For each distribution queue there are one or more sales channels through which the product is routed to one or more online stores. The receipts/payments 190 from the sales of the product 90 are collected in the billing/sales receipts records 127 of the distribution management module 120 and the proceeds of the sales of the product are stored as receipts/sales data 164 in the database 160.

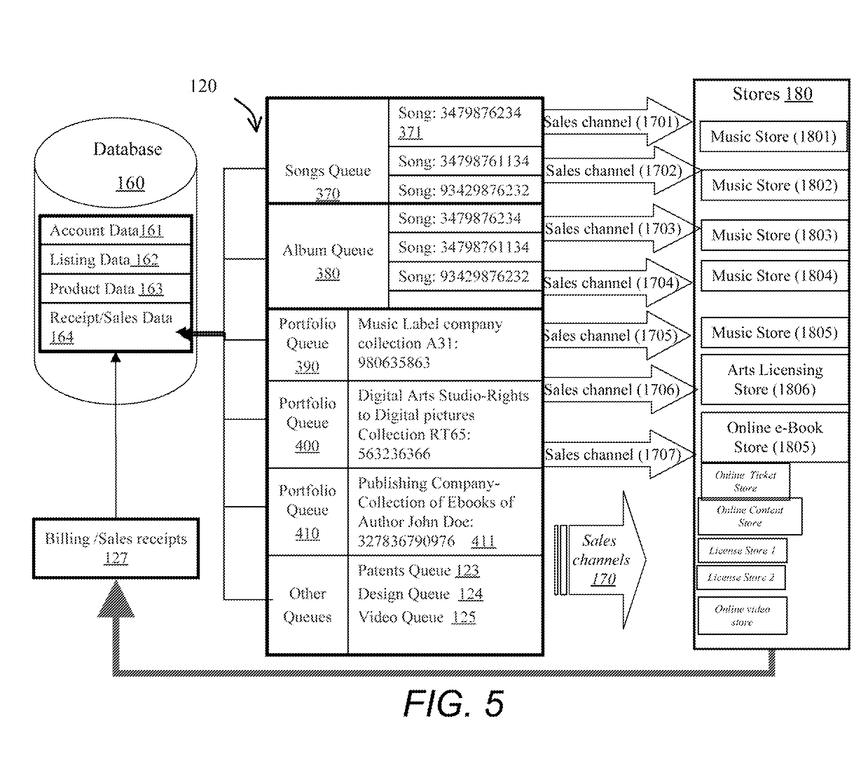

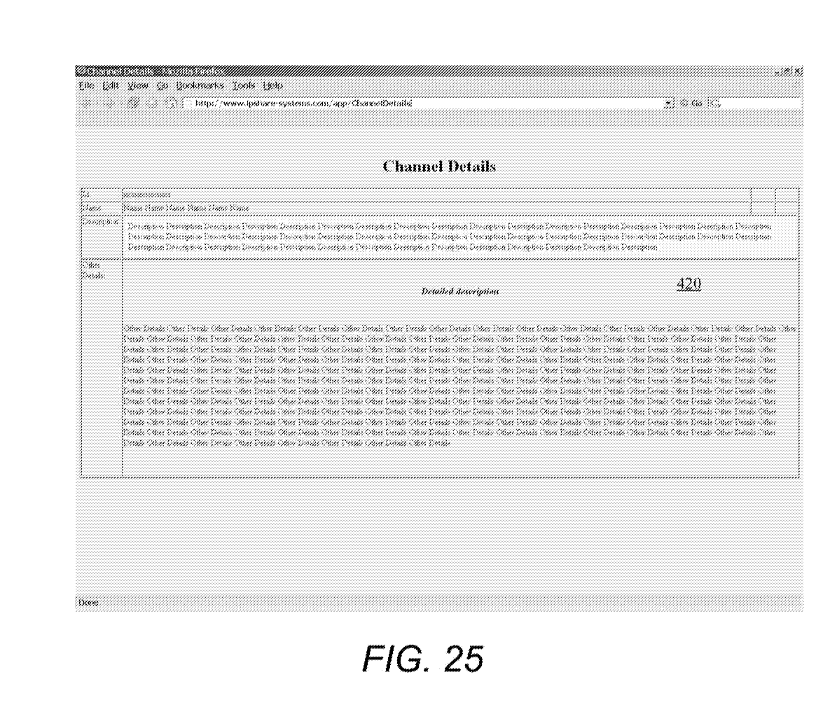

Referring to FIG. 5, in one example, the product 90 is a song and the distribution management module 120 assigns a unique identification number 371 to the song and places the song along on the songs queue 370. More than one songs are placed in the song distribution queue 370. A group of songs is packaged as an album and placed in the album queue 380. An entity that is the legal owner of a group of songs creates a portfolio of songs and adds a listing for the portfolio as a product. The distribution management module 120 retrieves the portfolio product from the product data and places it in the portfolio queue 390. In another example, the product is a collection of books by a specific author in e-book format 411. The e-books and information related to the author, fiction or non fiction, ISBN number and publisher are placed in the book portfolio queue 410. Other examples of products distributed through the distribution management module 120 include patents, designs, videos or a streaming broadcast of a baseball game which are placed in a patent queue 123, a design queue 124, and a video queue 125, respectively, shown in FIG. 1. These examples do not convey the meaning that queues exist at a high level such as music, videos, books, patents, and designs, among others, but rather that queues are designed based on the characteristics of the property. Music may be an individual song, an album of songs, or copyrights to use a tune. Each of these product offerings has a separate distribution queue. In another aspect, the invention provides a set of product catalogs for a distribution queue. According to this aspect each distribution queue is associated with one or more product catalogs. The product catalogs facilitate searching of the products. The distribution management module 120 provides a set of sales channels 1701 to 1706 for each distribution queue. This aspect of the system provides a mechanism for a sales channel to consume the products in the catalog and send the information to the on-line stores 180. In one example, shown in FIG. 5, a sales channel 1701 and 1702 provide connections from songs queue 370 to music stores 1801 and 1802. The online stores 180 send back the sales information related to each product sale 190 back to the distribution management module 120 where they are collected in the billings/sales receipts 127 data and then transferred to the receipts/sales data 164 of the database 160 for storage. The sales channels are built or customized specifically for each type of product and can have varying sequence of transactions and workflow as described in the above mentioned examples. Each sales channel is defined by a set of agreements and communication channels put in place between sales stores and the exchange system 100. These agreements include the details of the relationship between the store and the exchange system 100, sales commissions, payment structure, and variables of the products. The variables of the product include sale price, delivery date, availability, among others. These product variables are determined during the listing process and becomes part of the listing. Product attributes also determine if a particular product is available to a particular sales channel. For example, if the product is an audio book, this product will not be available through a channel associated with songs store, but a customized audio book channel. The details of the distribution management module 120 are published by the exchange system 100 so that product owners can do validation studies for putting products up for listing and setting the trading price of a listing. An example of the details of a channel is shown in the screen 420 of FIG. 25. Screen 420 provides details such as the description, and sales agreement between the exchange 100 and an on-line market store 180.

The communication modes between the sales channels 170 and the online stores 180 are developed while the channels are put in place and they include various communication product protocols. The communication product protocols include product delivery mechanisms, catalog uploads/downloads, sales record, invoices, and money transfers, among others. The communication protocols are based on standard Internet communication mechanisms such as TCP/IP, HTTP, SOAP, Web Services, EBXML, and product catalog protocols based on XML, among others. The network 80 via which these communications occur may be wired or a wireless network, shown in FIG. 1.

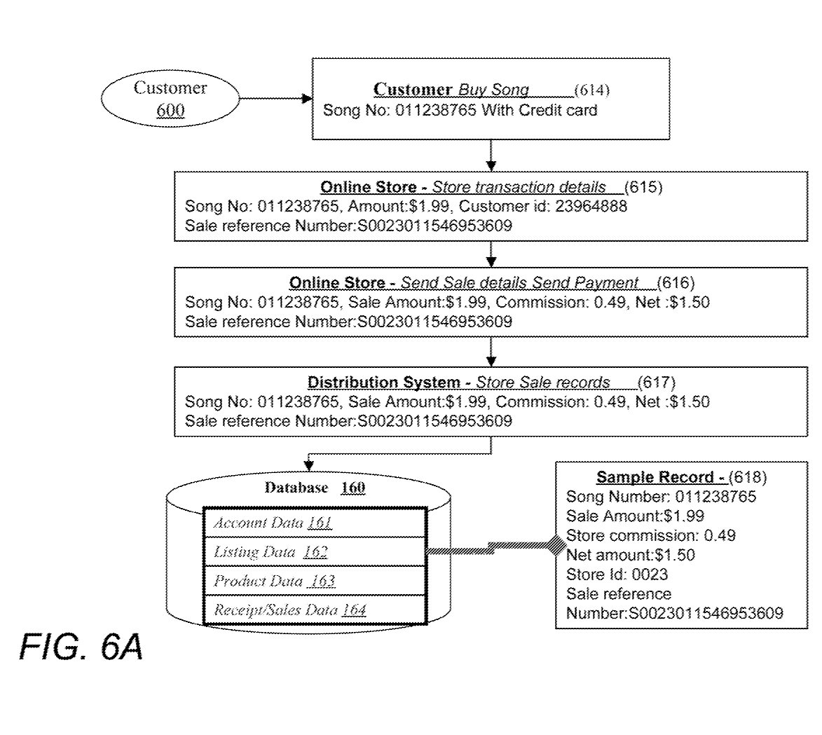

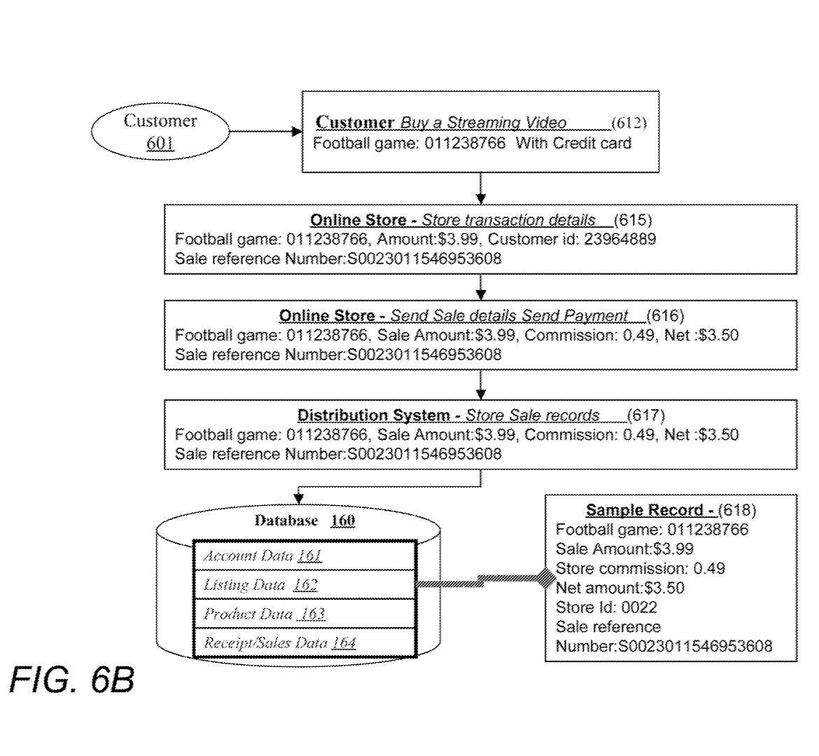

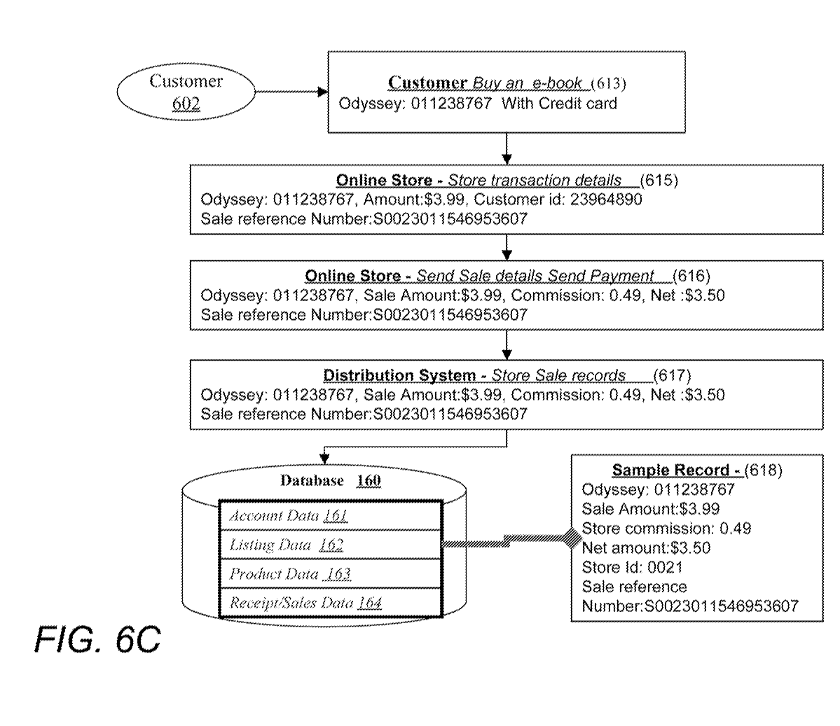

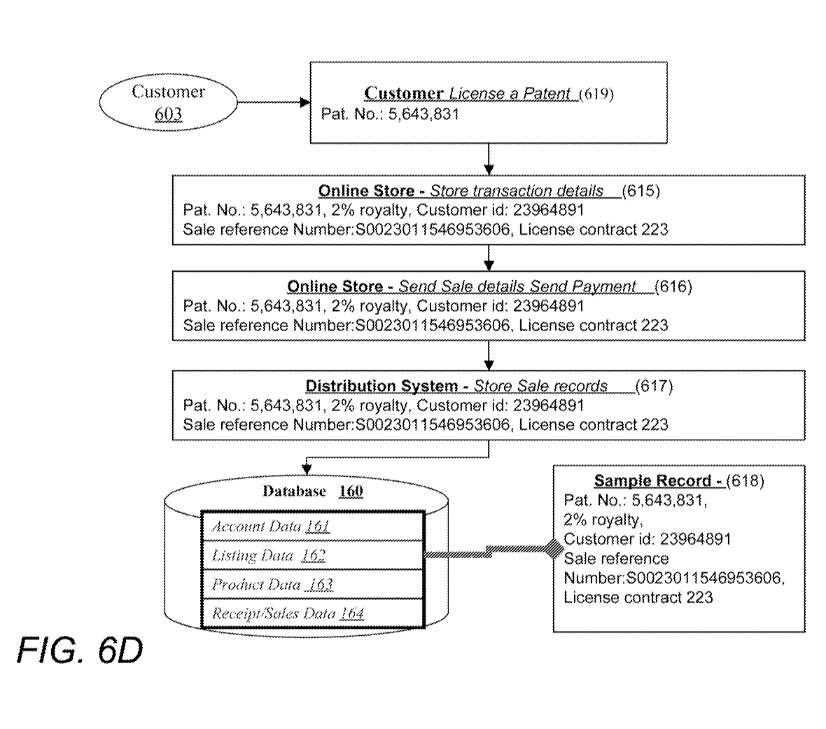

The process for a sales transaction varies depending on the type of product, types of on-line stores 180 and the agreement between the system 100 and the online stores 180. Referring to FIG. 6A, a sale transaction associated with the sale of a song includes the following steps. First a customer (600) visits the online music store 180 and purchases a song for $1.99 from the store (614). The online store 180 provides a facility to download the song to the customer's music system (613). Next, the online store 180 stores the sale transaction details in its database (615). The sale transaction details include song number, sale reference number and amount of the purchase, among others. Parts of the sale transaction details that are pertinent to the distribution module 120 are sent as a sale record to the distribution module (616). This sale record includes the sale amount, sale reference number, commissions, net amount, and song identifier, among others. The distribution module 120 stores the sale record along with the store details in the database 160 (617). A sample record of the transaction (618) is shown in FIG. 6.

Referring to FIG. 6B, a sale transaction associated with the sale of a streaming video of a football game or a TV show includes the following steps. First a customer (601) visits the online video store 180 and purchases a video for $3.99 from the store (612). The online video store 180 provides a facility to view the streaming video through the customer's web browser (611). Next, the online video store 180 stores the sale transaction details in its database (615). The sale transaction details include video identifier number, customer details, sale reference number and amount of the purchase, among others. Part of the sales transaction details that are pertinent to the distribution module 120 are sent as a sale record to the distribution module (616). This sale record includes the sale amount, sales reference number, commissions, net amount, and video identifier number, among others. The distribution module 120 stores the sale record along with the store details in the database 160 (617).

Referring to FIG. 6C, a sale transaction associated with the sale of an e-book includes the following steps. First a customer (602) visits the online bookstore 180 and purchases an e-book for $3.99 from the store (613). The online video store 180 provides a facility to download the e-book to the customer's computer or PDA and provides the license keys for viewing the book (611). Next, the online bookstore 180 stores the sale transaction details in its database (615). The sale transaction details include e-book identifier number, customer details, sale reference number and amount of the purchase, among others. Part of the sales transaction details that are pertinent to the distribution module 120 are sent as a sale record to the distribution module (616). This sale record includes the sale amount, sales reference number, commissions, net amount, and book identifier number, among others. The distribution module 120 stores the sale record along with the store details in the database 160 (617).

Referring to FIG. 6D, a sale transaction associated with the license for a patent or a design includes the following steps. First a customer (603) visits the online patent or design store 180 and licenses the patent or the design from the store (619). The online store 180 gathers all the necessary information from the customer to keep track of the patent or design license usage and provides the customer with the necessary contractual documents (611). Next, the online store 180 stores the sale transaction details in its database (615). The sale transaction details include license tracking number, customer details, sale reference number and amount of the purchase, among others. Parts of the sale transaction details that are pertinent to the distribution module 120 are sent as a sale record to the distribution module (616). This sale record includes the sale amount, sales reference number, commissions, net amount, and license tracking number, among others. The distribution module 120 stores the sale record along with the store details in the database 160 (617).

The disbursal management 130 module allocates the receipts from the receipt/sales data 164 to the listing data 162 of the database 160 and distributes the vested profits from the sales of the products to the accounts of the users in the account data 161, based on established disbursal policies. The vesting period is decided based on the distribution channel's sale terms and other relevant information such as performance guarantees, and return policies, among others. The vesting period depends on the characteristics of the sales channel, type of product and agreements put in place with the sales channel. Only vested profits are distributed. In one example, if the product has a return policy of 30 days at certain sales channel and 60 days at another sales channel, the receipts from the first channel will have a vesting period of 30 days and the receipt from the second sales channel will have a vesting period of 60 days.

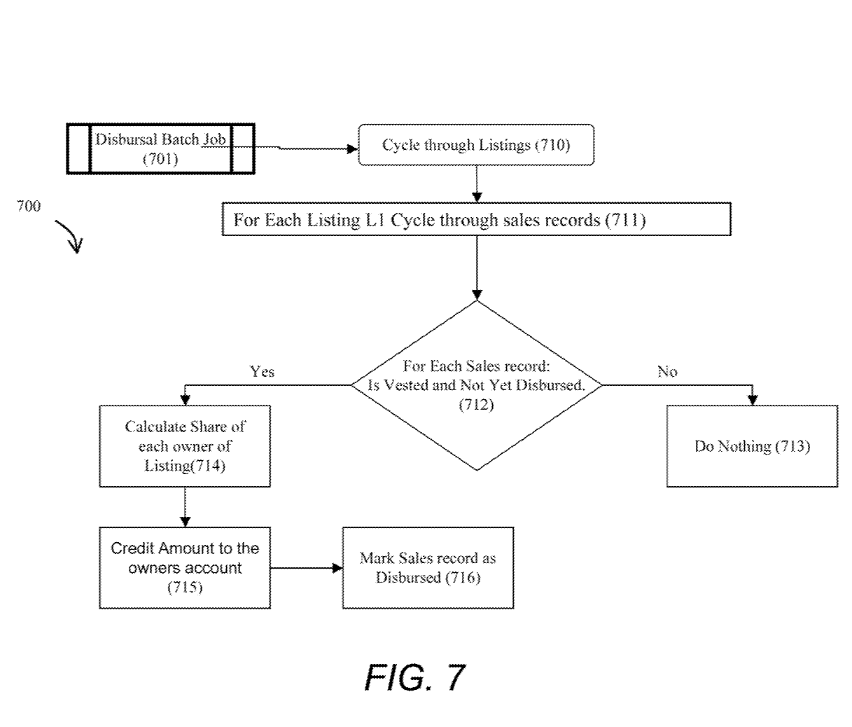

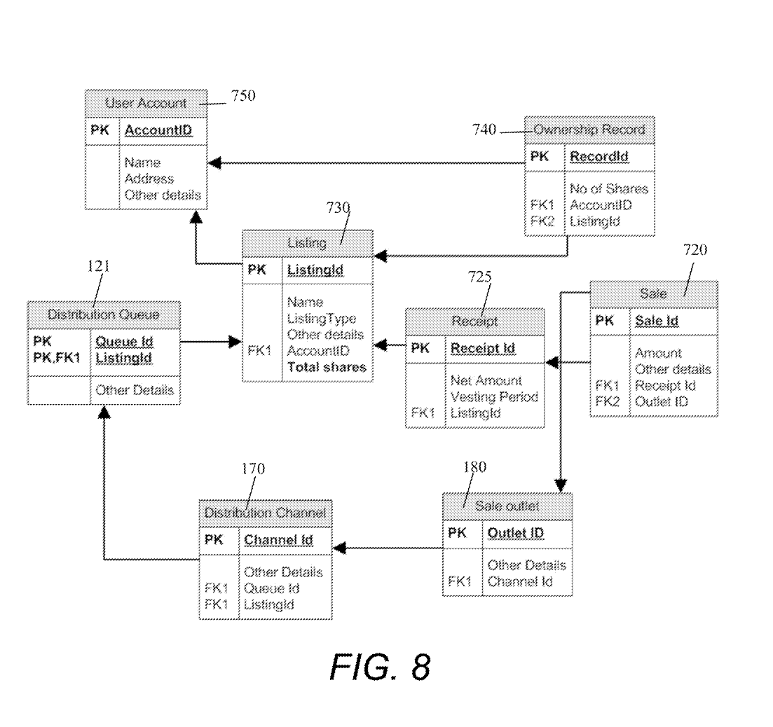

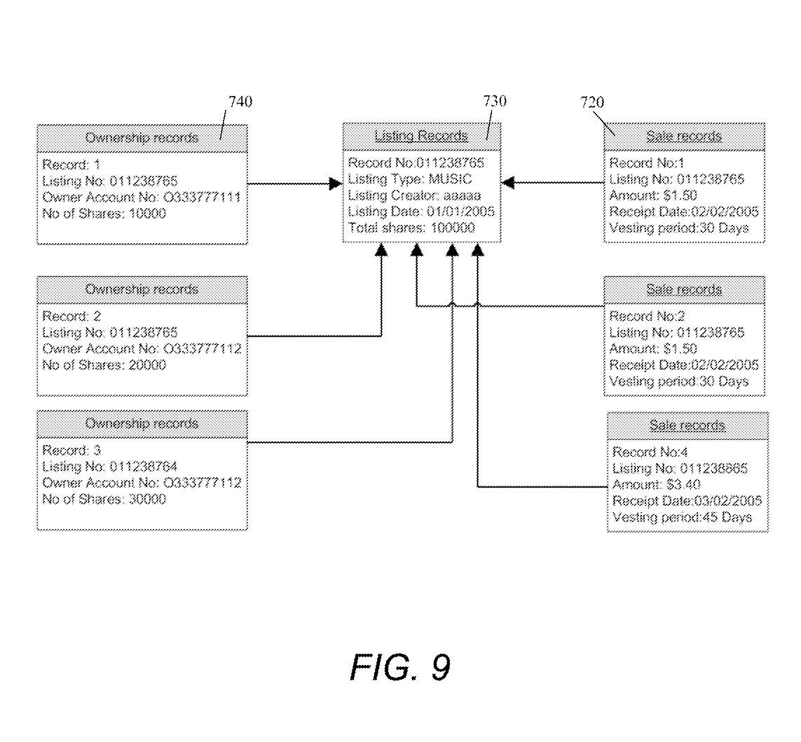

Referring to FIG. 7, the disbursal method 700 includes the following steps. A disbursal batch job 701, i.e., computer program that runs at scheduled intervals and performs specific defined functions, cycles through the listings (710) and for each listing L1 cycles though the sales records list (711) and checks if that listing L1 received any new sales records and identifies the sales receipts for which the vesting period is complete and not yet disbursed (712). For each such sales record S1, the disbursal module 130 identifies the listing account (LA1), selects the sales receipt amount (A1), and identifies the total number of shares (TS1). For each listing L1 the disbursal module 130 identifies the ownership records O(n) and for each ownership record O1 it identifies the number of owned shares OS1. The disbursal module 130 then calculates the profit share for each of the owners for the listing (714), by multiplying the receipt amount A1 with the number of share of each owner OS1 and dividing by the total number of shares TS1. Next, the disbursal module 130 adds the profit share R1 to the account of the owner (715) and marks the sales record S1 as disbursed (716). A sales record S1 is a receipt with details of the sales a product 90. When an online store 180 sells one or more units of a product, the sale information is sent back to the distribution management module 130 and the distribution management module 130 stores that information in the billing/sales receipts 127, as shown in FIG. 5. The distribution management module 130 then transfers that information to the Receipts/Sales data 164 of the database 160. In a specific implementation of the system, the listing profits may be disbursed to the owners periodically after aggregating several sales. Examples of sales records 720, listing records 730 and ownership records 740 are shown in FIG. 9. The information contained in the sale record 720 is communicated to the listing record 730. The information contained in the ownership record 740 is also communicated to the listing record 730. The sale record 720 includes, the sale record number, the listing number, the amount, the date of receipt, and the vesting period. The listing record 730 includes the listing number, the listing type, the listing creator, listing date and number of all shares. The ownership record 740 includes the record number, listing number associated with this ownership record, owner account number and number of owned shares. Referring to FIG. 8, the information contained in the ownership record 740 is communicated to the user account 750. Similarly the information contained in the listing record 730 is communicated to the user account 750. Information contained in the sale records 720 and the receipts 725 are also communicated to the listing record 730. The listing record 730 is also updated through direct input from the distribution queue 121. The distribution queue 121 receives information about the sale record 720 from the sale store 180 through the distribution channel 170.

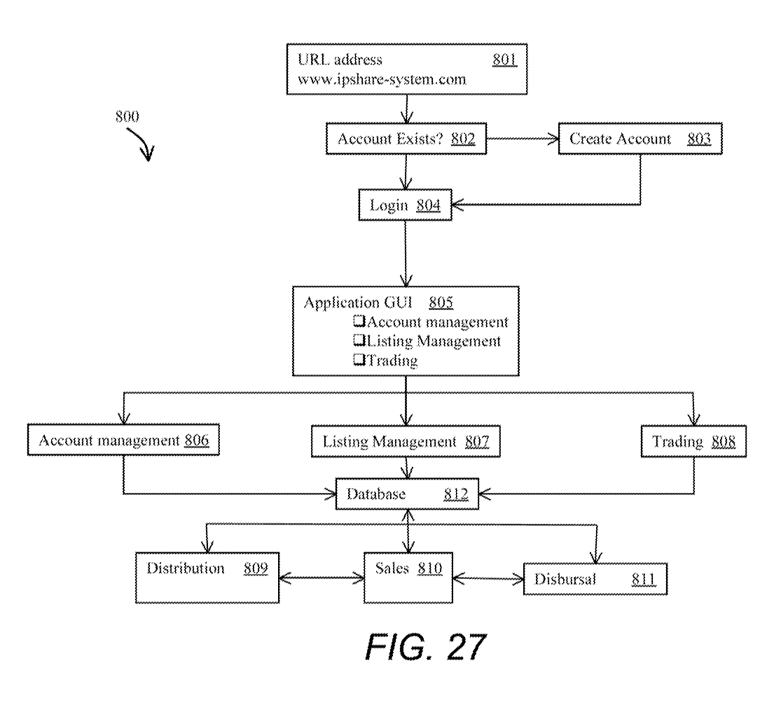

Referring to FIG. 27, a flow diagram 800 of the e-commerce and investment method of this invention includes the following steps. A prospective user accesses the website of the system 100 via an Internet connection by typing the URL address www.ipshare-system.com (801). If the user already has an account (802) with the system he logs in by entering his user id and password (803). If he does not have an account he is presented with the option to create an account (803) and then logs in the system (804). After the user successfully logs in, the system presents a graphical user interface (GUI) with the following choices: Account management, Listing management and Trading (805).

The Account Management screen allows the user to perform the following tasks: The user can make changes to his account such as changing password and setting preferences such as how the system displays his account information. The user can create a portfolio of listing shares he owns. For example, a user may create a portfolio of his favorite pop music listings he owns and give it a custom name. This enables him to view how his pop music collection portfolio performs. The user can track the performance data of various listings to see how they have performed over 3 months, 6 month, one year, or since inception. The user can track the performance of his account to see how his shares have performed over a period of time. The user can create a virtual portfolio and can track the performance over a period of time. The user can verify his transaction history. User can verify the disbursements into his account from listings and also can check the account balances.

The Listing Management screen (807) allows the user to perform the following tasks: The user after successfully logging in, and create a listing for his product. The graphical user interface provides step-by-step instructions for the users to enter details of the product and listing. The user is prompted to agree to the exchange system terms. After the user agrees to the exchange terms, the user is offered a screen to enter the listing details such as the owner details, total shares, and listing type. The system then offers a product type specific details screen to enter the details of the product and upload the product material. The system then matches the product type and offers the user a set of sales channel specific screen. The sales channel screens may be different for each product type and each store depending on the agreements between the exchange and the online stores. The sales channel screens offer the user to input values to variable parameters which will determine the price of the product. The system also offers the user the mechanism to upload ownership details through a screen. The listing is created in a “Waiting For Approval” status. When an officer of the exchange reviews the product details and ownership claims, the system provides a facility for the officer to change the status of the Listing as “Approved”. The system then creates shares as specified by the listing owner for the listing and the listing database is updated accordingly. All these shares are initially assigned to the creator of the listing. The new listing information is sent to the distribution system in order to sell the product through the online stores.

The trading screen (808) allows the user to perform the following tasks: The user after successfully logging in can use the trading features to buy/sell shares of a listing. The graphical user interface provides facilities to see the prices of different listings. The system also can provide research on various listings and how the listing is performing over a period of time. The system also provides the sales update for the listing based on the monies received from sales through various distribution channels. The user can refer to the research and decide to buy or sell his shares. All the shares of a new listing are assigned to the creator of the listing. An owner of shares of a listing can also put the shares up for sale. Any user of the system can buy shares. The trade matching matches the buy orders against sell orders. After successfully matching the buy orders to sell orders, the system fulfills the orders. After fulfilling the orders, the accounts of the buyer and seller are adjusted to reflect the changes of the ownership. The account cash balances are also adjusted to reflect the cost or proceeds of the sale of the shares by transferring the monies from the buyer of the shares to the seller of the share.

The online distribution process of the product includes the following steps (809). When a new listing is created for a song, the song is placed in a music queue for individual songs. This music queue is associated with one or more sales channels. Each sales channel is associated with an online store. The sales channels provide facilities to make this song available for the sales through this store. Accordingly, the channels provide the notification to the online stores and transfer the product, if necessary to the store.

An online sales transaction for a product includes the following steps (810). A customer visits an online music store. The customer purchases a song for $1.99 from the store. The online store provides facility to download the song to the customer's music system. The online store stores the sales transaction details in its database. The details will include song number, sale reference number and amount of the purchase, among others. Part of the sale information pertinent to the distribution is sent as a sale record to the distribution. This sale record contains sale amounts, sales reference number, commissions, net amount, and song identifier, among others. The distribution system stores the sale record along with the store details in the database (812).

The disbursal process allows the user to perform the following tasks. The amount of $1.99 resulting from the sale of the song is disbursed as follows: The online store keeps its commission for e.g. 25% of the price and sends the rest to the system. Approximately, $1.50 is sent as the payment. The system keeps a percentage as the commission for e.g. 10%. This results in net inflow into the listing of an amount of $1.35. This amount is credited to the listing to which this song belongs after the vesting period. This $1.35 is divided proportionately among all the owners of the listing based on the amount of shares of each owner.

Other embodiments include the following. The exchange system 100 may also be used to sell physical goods or properties where the physical goods or properties can be disposed off in one time sales. For example a store liquidation sale can be put up as a listing and several interested parties can own the shares and share the proceeds of the sale. The listing can then be closed after the sale of all physical goods of the store.

Several embodiments of the present invention have been described. Nevertheless, it will be understood that various modifications may be made without departing from the spirit and scope of the invention. Accordingly, other embodiments are within the scope of the following claims.

What is claimed is:

1. An online network based e-commerce and investment system for at least one non-physical good comprising:
a listing management module comprising means for generating an online product listing of said non-physical good and means for generating an online listing of ownership shares of said non-physical good;
a distribution management module comprising means for online selling and means for online distributing of one or more copies of said non-physical good; and
a trading management module comprising means for online investing and trading of said ownership shares of said non-physical good.

2. The system of claim 1 further comprising an account management module and said account management module comprises means for generating online user accounts, means for managing said online user accounts, means for maintaining user personal information, means for keeping track of user holdings of said ownership shares of said non-physical good in said user accounts, means for depositing profits from said selling of said copies of non-physical goods in said user accounts and means for transferring funds in and from said online user accounts.

3. The system of claim 2 further comprising an online database for storing said online user accounts information data, said online product listing data, said online listing data of ownership shares, and receipt/sales data for said copies of non-physical good.

4. The system of claim 3 further comprising a disbursal management module and said disbursal management module comprises means for online distributing of profits from said selling of said copies of said non-physical good into said online user accounts.

5. The system of claim 1 further comprising at least one online store for selling said copies of non-physical good.

6. The system of claim 5 further comprising at least one sales channel for distributing said copies of non-physical good to said online store.

7. The system of claim 6 comprising a plurality of product listings of non-physical goods, a plurality of listings of ownership shares of said non-physical goods, a plurality of online stores and a plurality of sales channels.

8. The system of claim 7 wherein said means for online distributing of copies of said non-physical goods comprise a plurality of distribution queues.

9. The system of claim 8 wherein said distribution queues are associated with one or more of said online sales channels.

10. The system of claim 9 wherein said online sales channels are associated with one or more of said online stores.

11. The system of claim 10 further comprising means for selecting one or more of said distribution queues, one or more of said online sales channels and one or more of said online stores for online selling said copies of non-physical goods.

12. The system of claim 1 wherein said non-physical good is selected from a group consisting of music recordings, video recordings, electronic books, patents, designs, drawings, reports, electronic tickets, electronic gift certificates, electronic tokens, electronic journals, electronic magazines, electronic newspapers, customized content, packaged subject matter, and combinations thereof.

13. The system of claim 5 wherein said online store is selected from a group consisting of online music stores, online video stores, online bookstores, online patent and design license stores, online content stores, online news store, online magazine store, e-learning centers, and combinations thereof.

14. The system of claim 2 wherein said account management module comprises an account management user interface and said account management user interface comprises a login screen, a logout screen, an account generation screen, a password setting and changing screen, a user personal information modification screen, a transfer fund screen, a transaction verification screen, ownership share holdings verification screen, a display screen for all ownership shares owned by a user, a performance display screen for all ownership shares owned by a user, an account balance screen for each user.

15. The system of claim 14 wherein said user personal information is selected from a group consisting of user identifications, passwords, addresses, bank account information and numbers, website information, e-mail addresses, and combinations thereof.

16. The system of claim 1 wherein said listing management module further comprises a listing user interface and said listing user interface comprises a screen for entering product listing information, a screen for online uploading product material for said non-physical good, a screen for updating said product material of said non-physical good, a screen for allocating number of ownership shares and price per ownership share of said non-physical good, a screen for browsing existing product listings, and a screen for browsing listings of ownership shares for non-physical goods.

17. The system of claim 1 wherein said means for online trading of said ownership shares comprise online selling, online buying, online exchanging, online trade matching of a sell order with a buy order, online fulfilling of trade orders and online reconciling and deducting costs associated with trade orders of said ownership shares.

18. The system of claim 1 wherein said trading management module comprises a trading user interface and said trading user interface comprises a screen for displaying number of available ownership shares and price per share of said non-physical good, a screen for placing a buy trade order for said ownership shares of said non-physical good, a screen for placing a sell trade order for said ownership shares of said non-physical good, screens for confirmation of buying and selling of ownership shares of said non-physical good, and a screen for displaying said buy and sell trade order status.

19. The system of claim 4 wherein said disbursal management module further comprises means for verifying vesting of said profits from said selling of said copies of said non-physical good.

20. The system of claim 4 wherein said disbursal management module further comprises means for deducting costs and commissions from said profits from said selling of said copies of said non-physical good.

21. The system of claim 1 wherein said listing management module further comprises means for proposing a change of said online listing of said ownership shares of said non-physical good, means for voting on said proposal for change by all owners of said ownership shares of said non-physical good, and means of implementing said voting result.

22. The system of claim 21 wherein said listing management module further comprises means for delisting said online listing of said ownership shares of said non-physical good.

23. The system of claim 1 wherein said online product listing of said non-physical good and said online listing of ownership shares of said non-physical good are generated by an owner of said non-physical good and wherein said listing management module further comprises means for entering proof of ownership of said non-physical good by said owner.

24. The system of claim 1 wherein said listing management module further comprises means for reviewing, verifying and approving said online product listing and said online listing of ownership shares of said non-physical good by an external entity.

25. The system of claim 1 wherein said listing management module further comprises means for providing pricing suggestions for said product listing.

26. The system of claim 1 wherein said listing management module further comprises means for providing valuation and number of ownership shares suggestions for said non-physical good.

27. The system of claim 6 wherein said sales channel comprises a sales agreement and said agreement comprises variables for determining pricing of said product listing.

28. The system of claim 1 further comprising means of entering directly an online product listing without engaging said listing management module.

29. A method for online selling and online investing in at least one non-physical good comprising:
providing at least one non-physical good;
providing an online network based e-commerce and investment system comprising a listing management module comprising means for generating an online product listing of said non-physical good and means for generating an online listing of ownership shares of said non-physical good; a distribution management module comprising means for online selling and means for online distributing of one or more copies of said non-physical good; and a trading management module comprising means for online trading of said ownership shares of said non-physical good;
generating an online product listing of said non-physical good and an online listing of ownership shares of said non-physical good with said listing management module;
selling and distributing online one or more copies of said non-physical good with said distribution management module; and
investing and trading online said ownership shares of said non-physical good with said trading management module.

30. The method of claim 29 wherein said e-commerce and investment system further comprises an account management module and said account management module comprises means for generating online user accounts, means for managing said online user accounts, means for maintaining user personal information, means for keeping track of user holdings of said ownership shares of said non-physical good in said user accounts, means for depositing profits from said selling of said copies of non-physical goods in said user accounts and means for transferring funds in and from said online user accounts.

31. The method of claim 30 wherein said e-commerce and investment system further comprises an online database for storing said online user accounts information data, said online product listing data, said online listing data of ownership shares, and receipt/sales data for said copies of non-physical good.

32. The method of claim 31 wherein said e-commerce and investment system further comprises a disbursal management module and said disbursal management module comprises means for online distributing of profits from said selling of said copies of said non-physical good into said online user accounts.

33. The method of claim 32 wherein said e-commerce and investment system further comprises at least one online store for selling said copies of non-physical good.

34. The method of claim 33 wherein said e-commerce and investment system further comprises at least one sales channel for distributing said physical good to said online store.

35. The method of claim 34 wherein said e-commerce and investment system further comprises a plurality of product listings of non-physical goods, a plurality of listings of ownership shares of said non-physical goods, a plurality of online stores and a plurality of sales channels.

36. The method of claim 35 wherein said means for online distributing of copies of said non-physical goods comprise a plurality of distribution queues.

37. The method of claim 36 wherein said distribution queues are associated with one or more of said online sales channels.

38. The method of claim 37 wherein said online sales channels are associated with one or more of said online stores.

39. The method of claim 38 wherein said e-commerce and investment system further comprises means for selecting one or more of said distribution queues, one or more of said online sales channels and one or more of said online stores for selling said copies of non-physical goods.

40. The method of claim 29 wherein said non-physical good is selected from a group consisting of music recordings, video recordings, electronic books, patents, designs, drawings, reports, electronic tickets, electronic gift certificates, electronic tokens, electronic journals, electronic magazines, electronic newspapers, and combinations thereof.

41. The method of claim 33 wherein said online store is selected from a group consisting of online music stores, online video stores, online bookstores, online patent and design license stores, online content stores, online news store, online magazine store and combinations thereof.

42. The method of claim 30 wherein said account management module comprises an account management user interface and said account management user interface comprises a login screen, a logout screen, an account generation screen, a password setting and changing screen, a user personal information modification screen, a transfer fund screen, a transaction verification screen, ownership share holdings verification screen, a display screen for all ownership shares owned by a user, a performance display screen for all ownership shares owned by a user, an account balance screen for each user.

43. The method of claim 42 wherein said user personal information is selected from a group consisting of user identifications, passwords, addresses, bank account information and numbers, website information, e-mail addresses and combinations thereof.

44. The method of claim 29 wherein said listing management module further comprises a listing user interface and said listing user interface comprises a screen for entering product listing information, a screen for online uploading product material for said non-physical good, a screen for updating said product material of said non-physical good, a screen for allocating number of ownership shares and price per ownership share of said non-physical good, a screen for browsing existing product listings, and a screen for browsing listings of ownership shares for non-physical goods.

45. The method of claim 29 wherein said online investing and trading of said ownership shares comprise online selling, online buying, online exchanging, online trade matching of a sell order with a buy order, online fulfilling of trade orders and online reconciling and deducting costs associated with trade orders of said ownership shares.

46. The method of claim 29 wherein said trading management module comprises a trading user interface and said trading user interface comprises a screen for displaying number of available ownership shares and price per share of said non-physical good, a screen for placing a buy trade order for said ownership shares of said non-physical good, a screen for placing a sell trade order for said ownership shares of said non-physical good, screens for confirmation of buying and selling of ownership shares of said non-physical good, and a screen for displaying said buy and sell trade order status.

47. The method of claim 32 wherein said disbursal management module further comprises means for verifying vesting of said profits from said selling of said copies of said non-physical good.

48. The method of claim 32 wherein said disbursal management module further comprises means for deducting costs and commissions from said profits from said selling of said copies of said non-physical good.

49. The method of claim 29 wherein said listing management module further comprises means for proposing a change of said online listing of said ownership shares of said non-physical good, means for voting on said proposal for change by all owners of said ownership shares of said non-physical good, means of implementing said voting result and means for delisting said online listing of said ownership shares of said non-physical good.

50. The method of claim 29 wherein said online product listing of said non-physical good and said an online listing of ownership shares of said non-physical good are generated by an owner of said non-physical good and wherein said listing management module further comprises means for entering proof of ownership of said non-physical good by said owner.

51. The method of claim 29 wherein said listing management module further comprises means for reviewing, verifying and approving said online product listing and said online listing of ownership shares of said non-physical good by an external entity.

52. The method of claim 29 wherein said listing management module further comprises means for providing pricing suggestions for said product listing.

53. The method of claim 29 wherein said listing management module further comprises means for providing valuation and number of ownership shares suggestions for said non-physical good.

54. The method of claim 34 wherein said sales channel comprises a sales agreement and said sales agreement comprises variables for determining pricing of said product listing.

55. The method of claim 29 further comprising means of entering directly an online product listing without engaging said listing management module.
